(19) United States
(12) Patent Application Publication
(10) Pub. No.: US 2010/0169234 A1
(43) Pub. Date: Jul. 1, 2010

(54) Method for Capturing the Essence of Product and Service Offers of Service Providers

(75) Inventors: Ramy METZGER, Oranit (IL); Ishay VENTURA, Modi'in (IL)

Correspondence Address: The Law Office of Michael E. Kondoudis, 888 16th Street, N.W., Suite 800, Washington, DC, 20006, US

(73) Assignee: WIZBILL LTD, Oranit (IL)

(21) Appl. No.: 12/644,189

(22) Filed: Dec. 22, 2009

Related U.S. Application Data
(60) Provisional application No. 61/142,201, filed on Jan. 1, 2009.

(51) Int. Cl. G06Q 10/00; G06Q 30/00; G06N 3/12; G06F 15/18; G06N 5/02

(52) U.S. Cl. 705/348; 706/13; 706/12; 706/47

(57) ABSTRACT

A computer implemented method of constructing a computer implemented knowledge base, of evaluating a plurality of invoices, of knowledge refinement and generation, as well as a computer implemented knowledge base for analyzing a plurality of invoices. The methods comprise receiving the invoices, semantic and logically analyzing them to identify the invoice items (parameters and algorithms of service providers, billing plans, user profile, consumption pattern and debits) and relations connecting them and construct the knowledge base. The knowledge base comprises a hierarchic taxonomy of billing plans related to services of any domain (telecommunications services, banking, insurance, utilities etc.) and a computer implemented generic invoice constructed in reverse engineering logic for simulating debits. Debit simulations are done in order to achieve: 1. recommendations for optimal billing plans. 2. Recommendations for possible detected billing errors. 3. recommendations concerning new plans and/or services, and their financial implications Improving the knowledge base may use genetic algorithms based on an analogous hierarchic structure of the taxonomy to a genetic hierarchy, and may proceed by refining billing plans and comparing the resulting debits. Novel Semantic-web and Artificial Intelligence (AI) methods are used.

### CROSS REFERENCE TO RELATED APPLICATION

This application claims the benefit of U.S. Provisional Application No. 61/142,201, filed Jan. 1, 2009.

### FIELD OF THE INVENTION

The present invention generally relates to the field of computerized methods. More particularly, the present invention relates to an invoice analyzing software.

### BACKGROUND OF THE INVENTION

In linguistics, syntax is the study of the rules that govern the structure of sentences, and which determine their relative grammaticality. Modern research in syntax attempts to describe languages in terms of such rules, and, for many practitioners, to find general rules that apply to all languages. The “Universal Grammar” model is used to explain language acquisition in general during child development. The theory was presented by Noam Chomsky, who was the first to observe that all languages have a common structural basis. This set of rules is known as Universal Grammar In addition, Noam Chomsky came up with a framework of Generative Grammar and realized that there is a set of rules or principles that recursively “specify” or “generate” the well-formed expressions of a natural language.

In linguistics, semantics is the subfield that is devoted to the study of meaning, as borne on the syntactic levels of words, phrases, sentences, and even larger units of discourse (referred to as texts). In semantics, the truth condition of a sentence is distinct from its meaning. The meaning of a sentence is conveyed if the truth conditions for the sentence are understood, whereas truth conditions are what obtain precisely when a sentence is true. For example, “It is snowing in Nebraska” is true precisely when it is snowing in Nebraska. More formally, we can think of a truth condition as what makes for the truth of a sentence in an inductive definition of truth.

Also called First-order predicate calculus (FOPC), First Order Logic (FOL) is a formal deductive system used by mathematicians, philosophers, linguists, and computer scientists. FOL is a system of deduction extending propositional logic by allowing quantification over individuals of a given domain (universe) of discourse. For example, it can be stated in FOL “Every individual has the property P”. FOL is widely used in Natural Language Processing (NLP) applications to describe the semantics of a language. FOL has the following syntax: Basically, any language—natural or not, may be translated into FOL, for example: “Every gardener likes the sun” (Ax) gardener(x)=>likes(x, Sun) “You can fool some of the people all of the time” (Ex)(At) (person(x)̂ time(t))=>can-fool(x, t).

The subject of ontology is the study of the categories of things that exist or may exist in some domain. The product of such a study, called ontology, is a catalog of the types of things that are assumed to exist in a domain of interest D from the perspective of a person who uses a language L for the purpose of talking about D. The types in the ontology represent the predicates, word senses, or concept and relation types of the language L when used to discuss topics in the domain D.

A Taxonomy in built out of Frames (concept invented by Marvin Minsky), which are used to encapsulate data and methods about entities and includes a collection of “slots” (we call them ‘Features’) consisting both attributes/values pairs and functional methods. Frames can inherit from other frames, and implicitly contain all Features contained in the inherited frame, unless the frame overrides the Feature with its own definition. Inheritance is established with an “IS-A” relationship. Other relationships that are used include: Aggregation “A-PART-OF”. (In linguistic called “hyponym”), Association “HAS-A” (Ownership, uses, location). Frame can employ Multiple-Inheritance and have a number of relationships which may be of any type.

An expert system, also known as a knowledge based system, is a computer program that contains the knowledge and analytical skills of one or more human experts, related to a specific subject. It is a paradigm to applying specific knowledge rather specific techniques which replicates experts-specialists knowledge for novices. This class of program was first developed by researchers in artificial intelligence. (A related term is wizard. A wizard is an interactive computer program that helps a user solves a problem). The principal distinction between expert systems and traditional problem solving programs is the way in which the problem related expertise is coded. In traditional applications, problem expertise is encoded in both program and data structures. In the expert system approach all of the problem related expertise is encoded in data structures only; none is in programs The domain propriety knowledge base is maintained using declarative methods that represent objects and semantic relationships within them. One of the benefits that expert systems share is the ability to cope with ever evolving content within a problem domain without the Sisyphean need to re-write the program code. Domain engineering refers to the activity of systematically modeling domains. Domain engineering originates from research in the area of software reuse, and can be used when constructing domain-specific reusable libraries.

DSL—A program is “declarative” if it describes what something is like, rather than how to create it i.e. describing the properties of the desired solution (the what), leaving unspecified the actual algorithm that should be used to find that solution (the how). Domain Specific Language (DSL) is a small, declarative language that offers expressive power focused on a particular problem domain. The DSL allows solutions to be expressed in the idiom and at the level of abstraction of the problem domain. Consequently, domain experts themselves can understand, validate, modify, and often even develop DSL programs. In addition, DSL programs are concise, self-documenting to a large extent, and can be reused for different purposes. DSLs embody domain knowledge, and thus enable the conservation and reuse of this knowledge. They allow validation and optimization at the domain level, and enhance productivity, reliability, maintainability and testability.

The Declarative programming paradigm may be positioned as the counter paradigm to the imperative programming paradigm that describes computation as statements that change a program state. Imperative programs are a sequence of commands for the computer to perform. Systems built using this level of abstraction and coded using imperative languages (e.g. C, FORTRAN, Java) are common in STOA.

Memetics—a neo-Darwinian approach to evolutionary models of cultural information transfer based on the concept of the meme. Started from a metaphor used in popular writings of Richard Dawkins, to describe a unit of information residing in the brain and is the mutating replicator in human cultural evolution, it has later turned into an approach in the study of self-replicating units of culture. It has been proposed that just as memes are analogous to genes, memetics is analogous to genetics.

Examples of memes include words, ideas, knowledge, algorithms, concepts, and so on. Just as genes propagate themselves in the gene pool by leaping from body to body via sperms or eggs, so memes propagate themselves in the meme pool by leaping from brain to brain, or from computer software to computer software via a process which in the broad sense, can be called imitation. If a scientist hears, or reads about, a good idea, he passes it on to his colleagues and students. He mentions it in his articles and his lectures. If the idea catches on, it can be said to propagate itself in the scientist being a basis for new ideas, and spreading from brain to brain. Memes should be regarded as living structures, not just metaphorically but technically.

Genetic algorithms are implemented as a computer simulation in which a population of abstract representations (called chromosomes or the genotype or the genome) of candidate solutions (called individuals, creatures, or phenotypes) to an optimization problem evolves toward better solutions. The evolution usually starts from a population of randomly generated individuals and happens in generations. In each generation, the fitness of every individual in the population is evaluated, multiple individuals are stochastically selected from the current population (based on their fitness), and modified (recombined and possibly randomly mutated) to form a new population. The new population is then used in the next iteration of the algorithm. Commonly, the algorithm terminates when either a maximum number of generations has been produced, or a satisfactory fitness level has been reached for the population.

A typical genetic algorithm requires two things to be defined: A genetic representation of the solution domain and a fitness function to evaluate the solution domain. A one-to-one mapping, from the products/service domain to the Darwin evolutional domain allows usage of genetic algorithms in order to be able to suggest new generation of mutation plan and service based on previous services and plan i.e. those appearing already in the knowledge base.

Present technology simulates plans to generated estimated invoices from information presented in service provider's standard contracts—information which is very partial, and do not include all information that is assimilated into the billing systems. Present technology requires re-programming each and every new plan presented by service providers, in a way that requires huge manual efforts, and eventually is completely unmanageable and unreliable. Present technologies provide recommendations without visibility, without the ability to trace and/or debug the content assimilated into the code, or to validate the implementation by compare its calculations to the original billing systems calculations. Finally, present technologies do not support recommendations for new plans and/or forecasting new plans financials.

The following patents and patent applications are incorporated herein by reference in its entirety: WO03005693 disclosing a method for determining the optimum tariff plan for users of telecommunication services; US2004067747 disclosing a method for managing wireless telecommunications bills; DE10332840 disclosing a method for transfer of payment, billing and pay plan information to users of mobile phones from network service providers, whereby information is transferred using the same syntax to permit ready comparison of price structures; US2002154751 disclosing a method for managing wireless communication device use including optimizing rate and service plan selection; US2001037269 disclosing a system and method for analyzing wireless communication records and for determining optimal wireless communication service plans; US2005271192 disclosing a method and system for detecting a change in at least one telecommunication rate plan; US2005220280 disclosing a system and method for rating alternative solutions, including comparing alternative telecommunication service plans to the preference indicators and the prior use data and rating at least one of the alternative telephone service plans in response to the comparison; US2003169863 disclosing a usage tracking and billing system that includes a hierarchy system made up of hierarchies containing entities representing the accountables, services, and service locations associated with usage data; US2002120540 disclosing a system and method for automatic analysis of rate information accomplished by extracting electronic usage information from an electronic bill payment and presentment (EBPP) system; and US2002196919 disclosing a method and system for analyzing and preparing an optimum telephone services call plan.

### SUMMARY OF THE INVENTION

The present invention discloses a computer implemented method of constructing a computer implemented knowledge base relating to a plurality of invoices. The invoices are generated by at least one billing system according to at least one billing plan and relating to at least one service provider, the invoices comprising parameters of at least one user profile, a plurality of invoice items, parameters of at least one user consumption pattern and at least one debit. The computer implemented method comprises: (i) receiving the plurality of invoices, (ii) semantic analyzing the plurality of invoices, (iii) logically analyzing the plurality of invoices, (iv) constructing the computer implemented knowledge base. The semantic analyzing comprise: (i) identifying parameters of the at least one service provider, (ii) identifying the parameters of at least one user profile, (iii) identifying the invoice items of the plurality of invoices relating to the at least one billing system and the at least one service provider, (iv) identifying the parameters of at least one user consumption pattern, (v) identifying the at least one debit, (vi) identifying the at least one billing plan. The logically analyzing the plurality of invoices comprises: (i) identifying relations between the at least one debit and at least one of the following: the parameters of the at least one service provider, the parameters of the at least one user profile, the plurality of invoice items, the parameters of at least one user consumption pattern, (ii) extracting at least one itemization rule utilizing identified relations, wherein the itemization rules utilize a reverse engineering logic. Constructing the computer implemented knowledge base comprises: (i) at least one taxonomy representing an hierarchic structure of the relations and inheritance between the billing plans based on the semantic and logically analyzing of the plurality of invoices by identifying difference and similarities between invoice related to different billing plans, (ii) at least one computer implemented generic invoice for calculating an estimated debit from at least one of the following: the plurality of invoice items, the parameters of at least one user profile and the parameters of at least one user consumption pattern, wherein the at least one rule is extracted from the plurality of invoices by utilizing a reverse engineering logic.

In embodiments, the computer implemented method further comprises: (i) evaluating the computer implemented knowledge base, (ii) reconstructing the computer implemented knowledge base according to the correcting at least one of the itemization rules, the at least one taxonomy of the billing plans and the computer implemented generic invoice. Evaluating the computer implemented knowledge base comprises: (i) simulating debit calculation by entering parameters of invoices to the computer implemented knowledge base, (ii) comparing the results of the simulating debit calculation to debits of corresponding invoices, (iii) correcting at least one of the itemization rules, the at least one taxonomy of the billing plans and the computer implemented generic invoice in relation to the comparing of the simulated debits to debits of corresponding invoices. In embodiments, the computer implemented method further comprises reiterating the evaluating the computer implemented knowledge base and the reconstructing the computer implemented knowledge base such that the reconstructing the computer implemented knowledge base reduce the differences between the results of the simulating debit calculation and the debits of corresponding invoices. In embodiments, reiterating the evaluating and the reconstructing the computer implemented knowledge base utilizes genetic operators. In embodiments, the semantic analyzing and the logically analyzing utilize algorithms of bio-informatics. In embodiments, constructing the at least one taxonomy of billing plans in the knowledge base is carried out analogous to a genetic hierarchy, such that the invoice is analogous to a cell, billing plans are analogous to chromosomes, an itemization rule is analogous to a gene, and an invoice item is analogous to a genotype, and such that the constructing the computer implemented knowledge base is carried out utilizing genetic algorithms.

The present invention further discloses a method of evaluating a plurality of invoices generated by at least one billing system according to at least one billing plan and relating to at least one service provider, the invoices comprising parameters of at least one user profile, a plurality of invoice items, parameters of at least one user consumption pattern and at least one debit. The method comprises: (i) receiving the plurality of invoices, (ii) analyzing the plurality of invoices, (iii) constructing a computer implemented knowledge base, (iv) receiving simulated data comprising at least one of the following: at least one billing plan, at least one billing system, at least one service provider, at least one parameter of at least one user profile, at least one parameter of at least one user consumption pattern, (v) calculating at least one estimated debit from the simulated data and the computer implemented knowledge base. Analyzing the plurality of invoices comprises: (i) semantic analyzing the plurality of invoices, the semantic analyzing comprising identifying at least one of the following: Parameters of the at least one service provider, the parameters of at least one user profile, the invoice items of the plurality of invoices relating to the at least one billing system and the at least one service provider, the at least one billing plan, the parameters of at least one user consumption pattern, and the at least one debit, (ii) logically analyzing the plurality of invoices, the logically analyzing comprising identifying relations between the at least one debit and at least one of the following: The parameters of the at least one service provider, the parameters of the at least one user profile, the plurality of invoice items, the parameters of at least one user consumption pattern; and extracting itemization rules according to the identified relations. Constructing a computer implemented knowledge base comprises: (i) at least one taxonomy representing an hierarchic structure of the relations and inheritance between the billing plans based on the semantic and logically analyzing of the plurality of invoices by identifying differences and similarities between invoice related to different billing plans, (ii) at least one computer implemented generic invoice for calculating an estimated debit from at least one of the following: the plurality of invoice items, the parameters of at least one user profile and the parameters of at least one user consumption pattern, wherein the at least one itemization rule is extracted from the plurality of invoices by utilizing a reverse engineering logic. In embodiments, the method of evaluating a plurality of invoices further comprises generating at least one recommendation for alternative user choices regarding at least one of the following: at least one billing plan, at least one billing system, at least one service provider, at least one parameter of at least one user profile, at least one parameter of at least one user consumption; the at least one recommendation is according to the results of comparing the at least one estimated debit to the at least one debit, wherein the simulated data represent the alternative user choices.

The present invention further discloses a computer implemented knowledge base for analyzing a plurality of invoices, the invoices generated according to at least one billing plan by at least one billing system and relating to at least one service provider, the invoices comprising parameters of at least one user profile, a plurality of invoice items, parameters of at least one user consumption pattern and at least one debit. the computer implemented knowledge base comprises: (i) at least one taxonomy representing an hierarchic structure of the relations and inheritance between the billing plans based on semantic and logically analyzing of the plurality of invoices for extracting a plurality of rules by identifying differences and similarities between invoices related to different billing plans, (ii) at least one computer implemented generic invoice for calculating an estimated debit from at least one of the following: the plurality of invoice items, the parameters of at least one user profile and the parameters of at least one user consumption pattern, wherein the plurality of rules is extracted from the plurality of invoices by utilizing a reverse engineering logic. In embodiments, the at least one taxonomy of billing plans is constructed analogous to a genetic hierarchy, such that the invoice is analogous to a cell, billing plans are analogous to chromosomes, an itemization rule is analogous to a gene, and an invoice item is analogous to a genotype, and such that the at least one taxonomy of billing plans is analyzed utilizing genetic algorithms. In embodiments, the computer implemented knowledge base further comprises: (i) a history module arranged to save at predefined periods a time stamp and at least one of: at least one taxonomy; at least one computer implemented generic invoice, associated with the time stamp, (ii) a reconstruction module for using a historical version of at least one of: at least one taxonomy; at least one computer implemented generic invoice, the historical version defined by the time stamp. The reconstruction module is arranged to allow calculations with a prior version of at least one of: at least one taxonomy, at least one computer implemented generic invoice.

The present invention further discloses a computer implemented method of knowledge refinement and generation related to a computer implemented knowledge base for analyzing a plurality of invoices. The invoices are generated according to at least one billing plan by at least one billing system and relating to at least one service provider, the invoices comprising parameters of at least one user profile, a plurality of invoice items, parameters of at least one user consumption pattern and at least one debit, the computer implemented knowledge base comprising at least one computer implemented generic invoice for calculating an estimated debit from at least one of the following: the plurality of invoice items, the parameters of at least one user profile and the parameters of at least one user consumption pattern. The computer implemented method comprises: (i) defining a plurality of predefined threshold debits, (ii) generating a plurality of billing plans, (iii) calculating for each billing plan a plurality of associated debits, (iv) selecting a plurality of precursor billing plans from the plurality of billing plans relating to the plurality of associated debits, such that the selected precursor billing plans comprise billing plans minimizing at least one predefined function of said associated debits, (v) generating a plurality of progeny billing plans from the plurality of precursor billing plans, such that every progeny billing plan is substantially similar to at least one precursor billing plan, (vi) reiterating the calculating a plurality of associated debits, the selecting precursor billing plans and the generating a plurality of progeny billing plans, the reiterating is carried out until the associated debits reach the predefined threshold debits for at least one billing plan.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a block diagram of a system for analyzing the billing system in a telephony service provider, according to some embodiments of the invention;

FIG. 2 is a block diagram illustrating parts of and processes in an expert system for analyzing a billing system, according to some embodiments of the invention;

FIG. 3 is a flowchart illustrating the learning process of an expert system for analyzing a billing system according to some embodiments of the invention;

FIG. 4 is a block diagram illustrating the analogy between a payment system of a service provider and a population of organisms, according to some embodiments of the invention;

FIG. 5 is a block diagram of an expert system for analyzing a billing system, according to some embodiments of the invention;

FIG. 6 is a block diagram of the relations of an implementation of an expert system for analyzing a billing system to customers and clients, according to some embodiments of the invention;

FIG. 7 is a block diagram of an expert system for analyzing a billing system, according to some embodiments of the invention;

FIG. 8 is an example depicting an Abstract Syntax Trees (AST) versus a semantic augmented tree according to some embodiments of the invention;

FIG. 9 is a flowchart illustrating a method for evaluating a plurality of invoices according to some embodiments of the invention;

FIG. 10 is a flowchart illustrating method of constructing a database for analyzing invoices according to some embodiments of the invention;

FIG. 11 is a flowchart illustrating a computer implemented method of constructing a computer implemented knowledge base, according to some embodiments of the invention;

FIG. 12 is a flowchart illustrating a computer implemented method of evaluating the computer implemented knowledge base that may be added to the method illustrated in FIG. 11 according to some embodiments of the invention;

FIG. 13 is a flowchart illustrating a method of evaluating a plurality of invoices, according to some embodiments of the invention;

FIG. 14 is a block diagram illustrating a computer implemented knowledge base for analyzing a plurality of invoices, according to some embodiments of the invention;

FIG. 15 is a flowchart illustrating a computer implemented method of knowledge refinement and generation related to a computer implemented knowledge base for analyzing a plurality of invoices, according to some embodiments of the invention;

FIG. 16 is a flowchart illustrating a method of evaluating a plurality of billing plans, according to some embodiments of the invention.

### DETAILED DESCRIPTIONS OF SOME EMBODIMENTS OF THE INVENTION

The present invention discloses a method for capturing the essence of product and service offers and billing schemes of service providers. The method uses attributes and algorithmic methods to describe the offers. The method may be used to simulate consumption and costs and to produce forecasts thereof.

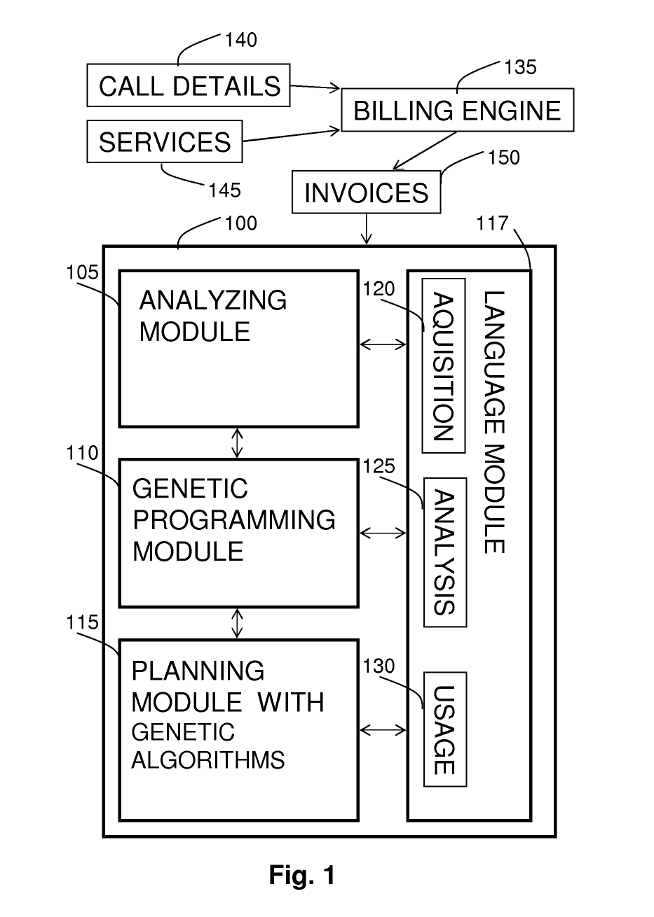

FIG. 1 is a block diagram of a system 100 for analyzing the billing system in a telephony service provider, according to some embodiments of the invention. FIG. 1 is an example of the general method for the case of a telephony service provider. A telephony service provider receives call details 140 and data of services used by a customer 145, calculates their costs using a billing engine 135 and produces invoices 150. The system 100 comprises an analyzing module 105, a module implementing genetic programming 110 and a planning module 115, all three modules coupled with a language module 117. The language module 117 comprises components for language acquisition 120, language analysis 125 and language usage 130.

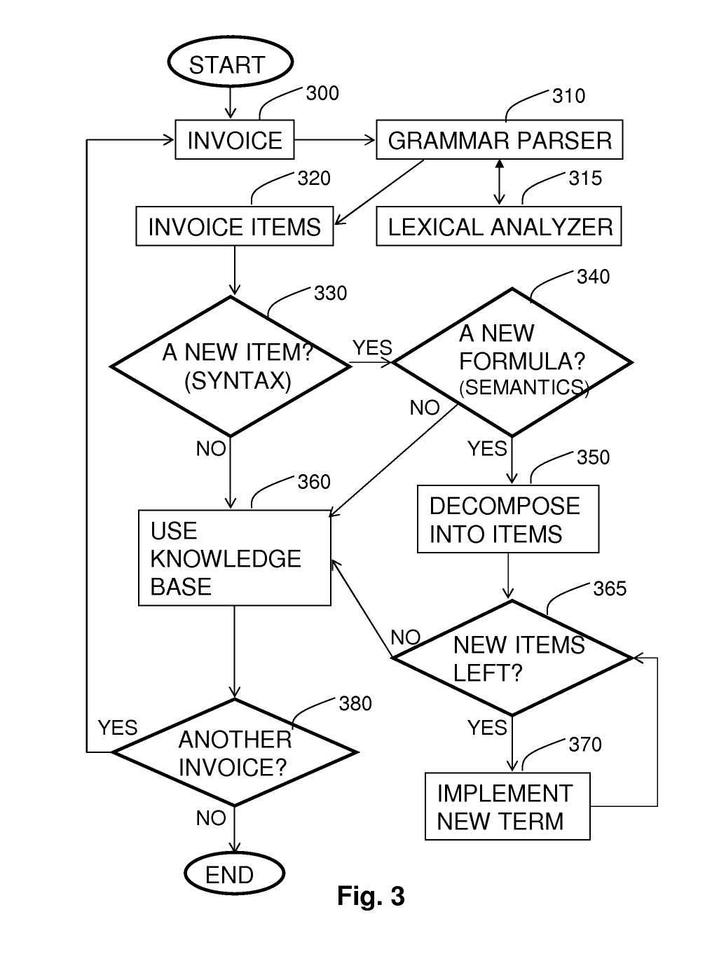

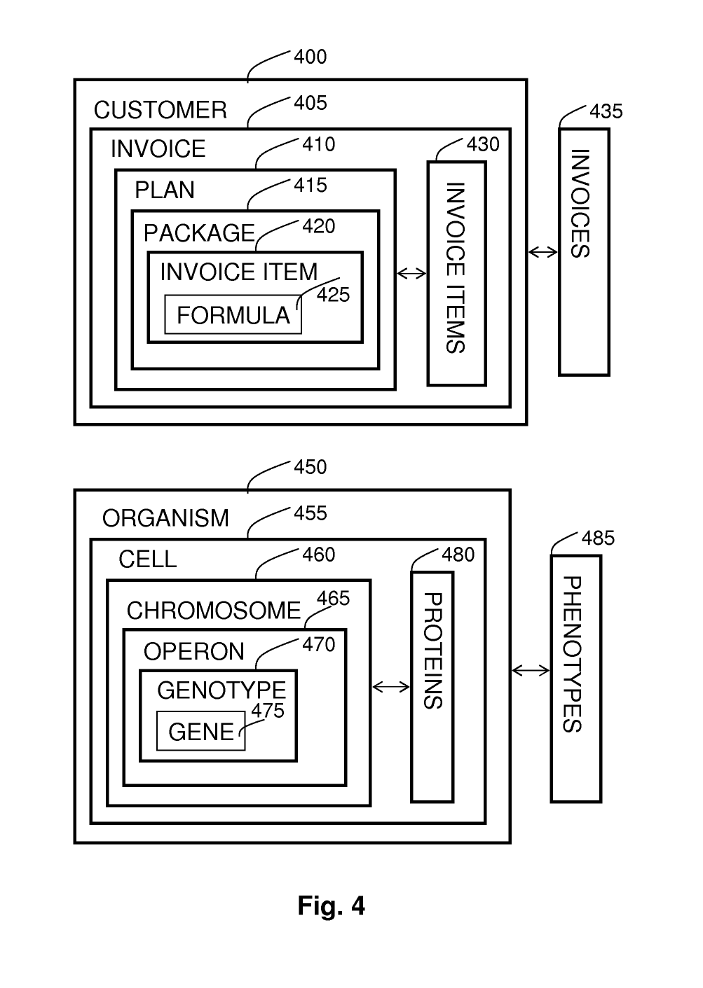

According to some embodiments of the invention, the analyzing module 105 uses a reverse engineering approach of constructing a language that is independent of language of the billing engine 135. The language comprises of semantic and syntax learned by the system semi automatically, with the help of experts and knowledge engineers. As the language is being built, ever larger parts of the learning are carried out automatically (see FIG. 3). The language is built in a modular manner and analogous to a genetic structure (see FIG. 4). The genetic structure is utilized for planning and optimizing a payment system of a customer using genetic algorithms. The language is built utilizing lexical and grammatical analysis.

According to some embodiments of the invention, the invoices 150 are written using the service provider's “invoice language”. An invoice language is a formal language that has its own syntax and semantics. The system 100 analyzes the service provider's offerings by understanding the invoice language. The system reveals the formal grammar standing behind specific invoice language (the one used to define or to ‘generates’ the invoices), which is a (possibly infinite) set of strings of symbols (invoice items) that may be constructed by applying production rules to a sequence of symbols which initially contains just the start symbol. Each invoice item captures an aspect of the usage and/or cost of a specific service 145, and embodies a calculation code belonging to the service provider's billing system, which describes the “meaning” (or semantics) of the consumption in terms of costs.

According to some embodiments of the invention, an implementation of First Order Logic (FOL) is utilized to describe the semantics of the invoices 150. The FOL implementation language is the major tool for analyzing the offerings implemented in the language module 117.

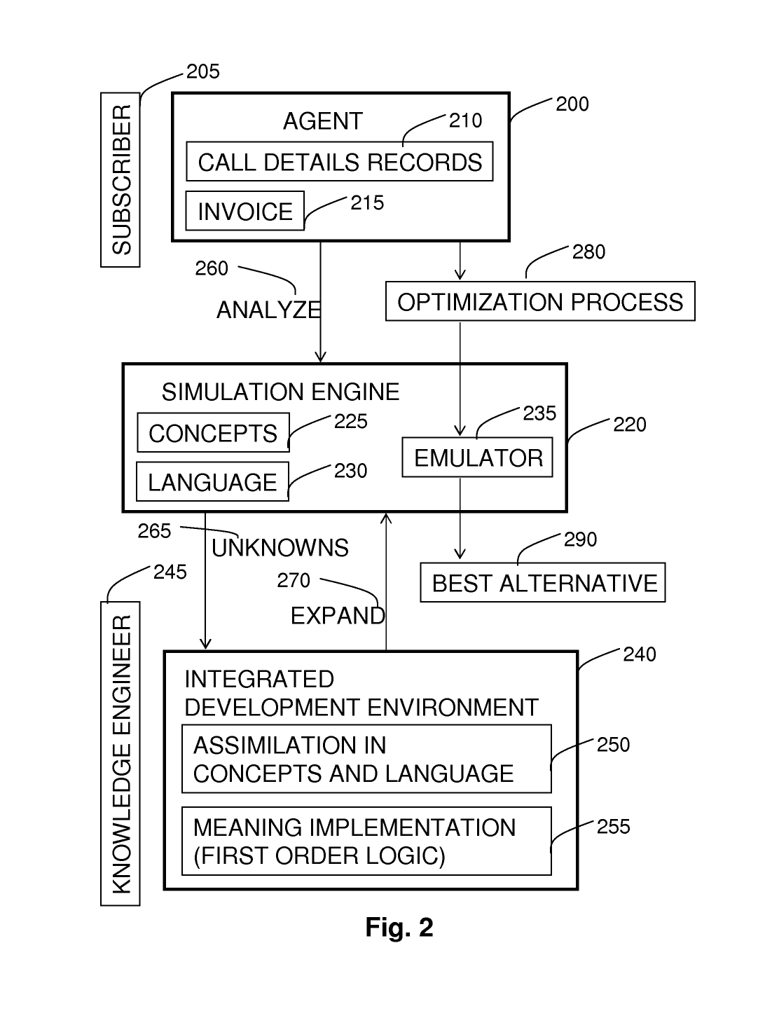

FIG. 2 is a block diagram illustrating parts of and processes in an expert system for analyzing a billing system, according to some embodiments of the invention. Information flows from an agent 200 operated by a subscriber 205 of the billing system. The information comprises of call details records 210 and invoices 215 issued by the billing system to the subscriber 205 and downloaded by the subscriber 205. The information is analyzed 260 by a simulation engine 220 into concepts 225 (such as plans, services and packages taxonomy, e.g. see FIG. 4) and language components 230 (e.g. utilizing generic invoices and their invoice items' semantics and syntax). The simulation engine 220 delivers unknowns 265 confronted with during the analysis 260 to an integrated development environment 240 operated by knowledge engineers 245. The integrated development environment 240 enables and prompts the knowledge engineers 245 to assimilate and implement the unknowns 265 in concepts and language 250 i.e. to implement the related meanings (semantics) using first order logic and associate language elements to a Generic-invoice structure 255. The learning process of the expert system is further illustrated in FIG. 3. The system thus understands the unknowns 265 and utilizes them to expand the concepts 230 and the language 230 in the simulation engine.

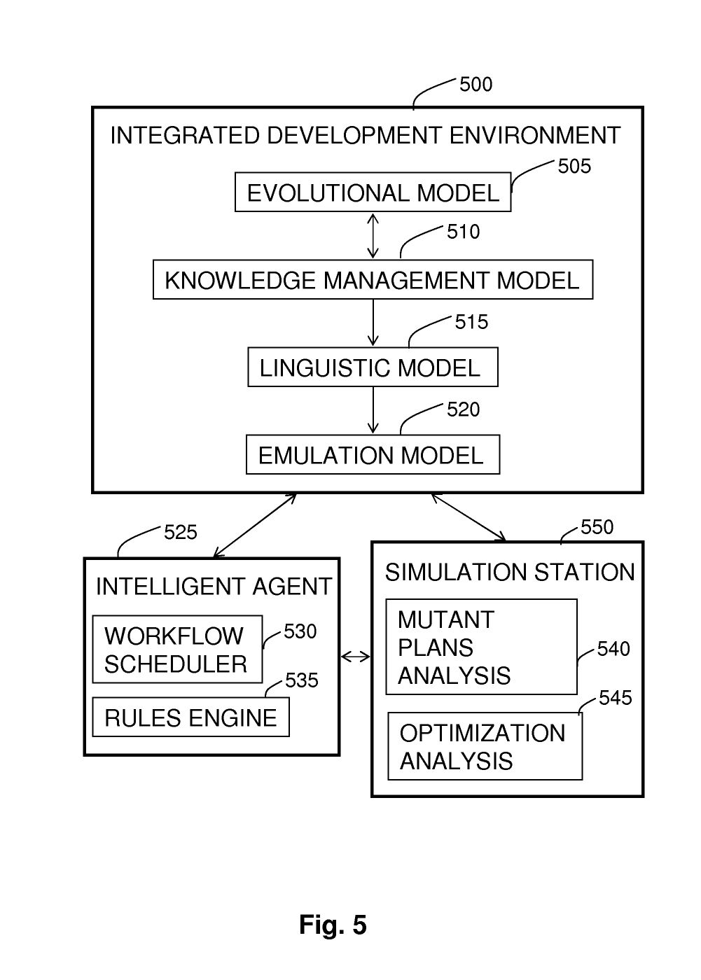

According to some embodiments of the invention, when the expert system establishes its simulation engine 220 using the integrated development environment 240, it may be engaged in an optimization process 280, utilizing an emulator 235 in the simulation engine 220. Different alternatives are processed by the emulator 235 to find the best alternative 290 that is to be given as a recommendation to the user, e.g. the subscriber or a service provider. The generation and comparison of alternatives is carried out by genetic algorithms as exemplified in FIGS. 1 and 5.

FIG. 3 is a flowchart illustrating the learning process of an expert system for analyzing a billing system according to some embodiments of the invention. Starting with an invoice 300, a grammar parser 310 is operated to analyze the grammar of the invoice 300, and a lexical analyzer 315 is operated to analyze the lexicon of the invoice 300. The invoice 300 is thus decomposed into invoice items 320. The system then checks 330 if all invoice items 320 are already known or are there new items, i.e. by checking the invoice-items titles and comparing them to ones stored in the knowledge-base 300. If an invoice items 320 is not known, yet the system thinks that its is an alias of a known invoice-item i.e. its formula is known (in 340) a knowledge base is used 360 to categorize and locate the known invoice-item which it assumes the new one is an alias of, and/or to suggest a place in the generic-invoice structure where a similar invoice-item may be found. The knowledge engineer receives the system's recommendation for an alias and defines the new invoice-item as an alias of an existing one and incorporates the invoice-item in the knowledge-base 300. if the knowledge engineer decides that the new invoice-item is not an alias of an existing one (340) than the invoice-items formula must be formulated. The system suggests invoice-items that may be similar (yet not identical) to the new one, and the knowledge engineer decomposes the suggested invoice-items' formulas 350 and uses those implemented terms that are relevant to the new invoice-item realization. The knowledge engineer possibly changes other terms to adapt to the new invoice-item (i.e. the new invoice-item is a mutation of an existing invoice-item), and sometimes he implements a new term from scratch 370 (i.e. a new DNA has been introduced into the system), until all new terms 365 are worked out. As described, the implementation stage 370 and the usage of the knowledge base 360 may be conducted semi-automatically by the system and supervised by knowledge engineers. The level of automation increases along the time as the system acquires and learns more and more invoice-items. After each invoice is analyzed, the system goes on to analyze the next invoice 380. According to some embodiments of the invention the analyzer may suggest to the engineer to use similar invoice-items that have already been implemented in past in implementing the new ones, and also may suggest place in the taxonomy where to insert the new plans and services.

FIG. 4 is a block diagram illustrating the analogy between a payment system of a service provider and a population of organisms, according to some embodiments of the invention. The analogy is used in order to be able to use algorithms from the bioinformatics, genetic programming and genetic algorithm.

A payment system of a service provider comprises formulas 425 (such as prices and terms) grouped to invoice items 420 (such as combinations of prices and terms) which are included in a service package 415. The service package 415 is a group of related invoice items 420 with their corresponding formulas 425. A plan 410 (e.g. a product offering's billing scheme) is a group of service packages 415 which are offered to an invoice 405 and characterize the invoice 405. A customer 400 may comprise several invoices 405. Invoice items 430 may be produced from the plans 410 and the service packages 415 (based on the invoice items 420 and the formulas 425), and are grouped to invoices 435, which are entered into the system 100.

In analogy, the basic units of an organism 450 are genes 475 (analogous to the formulas 425) grouped to genotypes 470 (analogous to the services 420), which are grouped to operons 465 (analogous to the service packages 415). Chromosomes 460 (analogous to the plans 415) comprise the operons 465 and are grouped to cells 455 (analogous to the invoices 405). Organisms 450 (analogous to the customers 400) comprise the cells 455. The operons 465 in the chromosomes 460 produce corresponding proteins (analogous to the invoice items 430), and different organisms, i.e. phenotypes 485 are analogous to the invoices 435.

According to some embodiments of the invention, the following analogy is utilized yet is non limiting to the invention: Organism is analogous to Subscriber—A subscriber is collection of its own invoices while an organism is a container of its own cells. Cell (Protein) is analogous to an invoice. Genome (DNA) is analogous to Service-Provider's-Billing-Schemas The information needed to create individuals i.e. the set of all viable Chromosomes (are duplicated in each of the individual Cells). A provider's Genome includes all information needed to bill its product offerings. Chromosome is analogous to Product-Offering's-Billing-Scheme. Operon is analogous to Invoice-Items-Group (realize a Package). A group of Genes whose products have related functions or realize a specific trait. E.g. A set of Genes defining the color of the eyes. Genotype is analogous to Invoice-Item (encodes a Sentence) (FOL Sentence) (A sentence is analogous to an atom, or, if P is a sentence and x is a variable, then (Ax)P and (Ex)P are sentences) An Invoice-Item codes Sentences of the from “Title=number” Examples: Ax formula (x)=>accumulate (x, Title). Gene is analogous to a Formula (encodes and gives meaning to a Title), or is analogous to FOL-Atom (either an n-place predicate of n terms, or, if P and Q are atoms, then ˜P, P V Q, P ̂ Q, P=>Q, P<=>Q are atoms) the Title's formula's calculation results with the Titles' value. Examples: preferred-numbers, belongs-to (preferred-numbers) ̂ begins-with (054) ̂ (˜grater(length(number), max-length)) etc. Codon is analogous to a Term (encodes and gives meaning to a Phrase) or is analogous to FOL-Term (a constant symbol, a variable symbol (i.e. “property”), or a function e.g. left-leg-of ( ). For example, x and f(x1 . . . xn) are terms, where each xi is a term) Examples: ‘fixed-Cost’, ‘tariff-Table’, ‘discount-percentage’, ‘validity-date’, ‘overdue-penalty’, SMS, cost-of(SMS), cost-scheme-of (preferred-numbers) etc. Nucleotide is analogous to a Symbol (encodes and gives meaning to a Word). Examples: ‘fixed’, ‘Cost’, ‘Tariff’, ‘Table’, ‘Discount’, ‘˜”, ‘V’, ‘̂’, ‘=>’, ‘<=’. Base ({A, G, T, C}) is analogous to English alphabet (FOL proprietary alphabet) DNA considered the “language of life”, the four bases its letters.

According to some embodiments of the invention, in an analogous way to genes (e.g. for eye color) have different alleles (as a Genotype, e.g. green, blue), and under the effect of the environment, genes are expressed to a phenotype (proteins amino acids)—the invoice title (e.g. web browsing) has different invoice items (e.g. costs info, bandwidth) that are expressed by invoice items calculations under the effect of subscriber environment to invoice lines realizing a service (‘invoice words’).

According to some embodiments of the invention, invoices 435 may be considered as phenotypes 485 (or proteins 480), representing physical appearance of chromosomes 460 in the domain. In order to reconstruct/reengineer service providers' product genome/DNA, the system must analyze a sufficient amount of phenotypes 485 that were generated by the genome. The reconstruction process is automated by enabling an automatic generation of FOL sentences, using semantics (equations) of genomes that have been reconstructed (or “mapped”) in the past.

According to some embodiments of the invention, a given offer is represented by a vector containing tens or hundreds of operons 465. Each operon 465 corresponds to a characteristic of consumption, for example, SMS, local calls, web browsing, money transfer etc. Telecommunication offers may have hundreds analogues operons 465, whereas utility offers may have tens of analogues operons 465, and financial offers may have an intermediate number of analogous operons 465. The system depends on a sufficient number of operons 465 to render useful results.

According to some embodiments of the invention, given a sufficiently large group of service provider's invoices 435, the system 100 is able to reveal and map the operons 465 and reconstruct the offering's DNA, for later simulations. Once the DNA has been reconstructed, it is possible to recommend and match offerings to customers 400 according to their consumption profiles.

According to some embodiments of the invention, the system 100 uses evolutionary algorithms such as genetic algorithms in order to perform simulations for answering the optimization question: Which population of offers representations (chromosomes 460 or the genotype or the genome) of candidate solutions to a consumption profile (phenotypes 485) evolves toward better solutions? Given a vector of one or more offers, a list of other similar offerings is constructed using a distance function. The system utilizes techniques that are inspired by evolutionary biology, such as simulation of inheritance, mutation, selection, and crossover (also called recombination) to both represent the domain knowledge and to use it during simulations.

Whereas in biological applications each successive generation, a proportion of the existing population is selected to breed a new—stronger generation, according to some embodiments of the invention, the new selected generation is expected to deliver less expensive bills for the given consumption profiles.

FIG. 5 is a block diagram of an expert system for analyzing a billing system, according to some embodiments of the invention. The system comprises of an integrated development environment 500, a simulation station 550 and an intelligent agent 525. The integrated development environment 500 comprises an evolutionary model 505, a knowledge management model 510, a linguistic model 515 and an emulation model 520. The evolutionary model 505 implements genetic programming and algorithms, the knowledge management model 510 uses an ontology mechanism to represent knowledge, i.e. constructs an hierarchical catalog of the types of things that are assumed to exist in a domain of interest, representing the predicates, word senses, and concept and relation types of the language. The linguistic model 515 constructs and manipulates the syntax and semantics of the language, and the emulation model 520 constructs and executes domain specific languages (DSL) for the exact billing emulation of and for the understanding of the invoices of the billing system and for allowing the knowledge engineers check and compare plans. The required information and knowledge for checking and comparing plans, that are invisible in the contracts, reveal themselves through the invoices processed by the expert system for knowledge acquisition. The simulation station 550 performs mutant plans analysis 540 and an optimization analysis 545 for entering to the evolutionary model 505 and for plan comparison via the emulation model 520. The intelligent agent 525 comprises a workflow scheduler 530 and a rules engine 535 for controlling the processes.

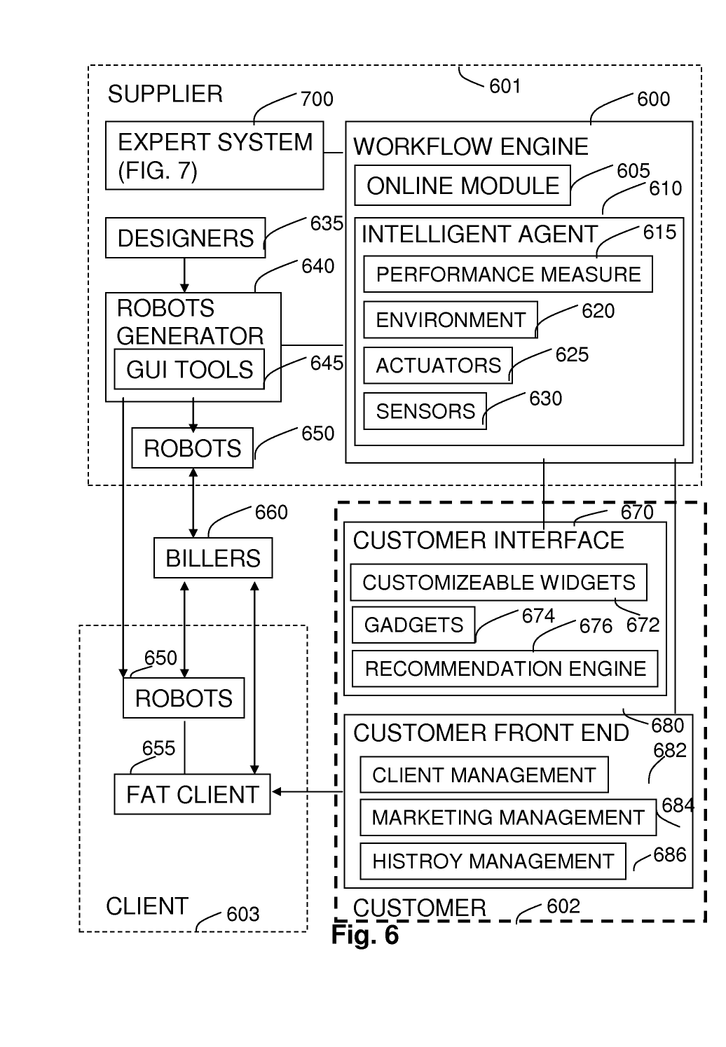

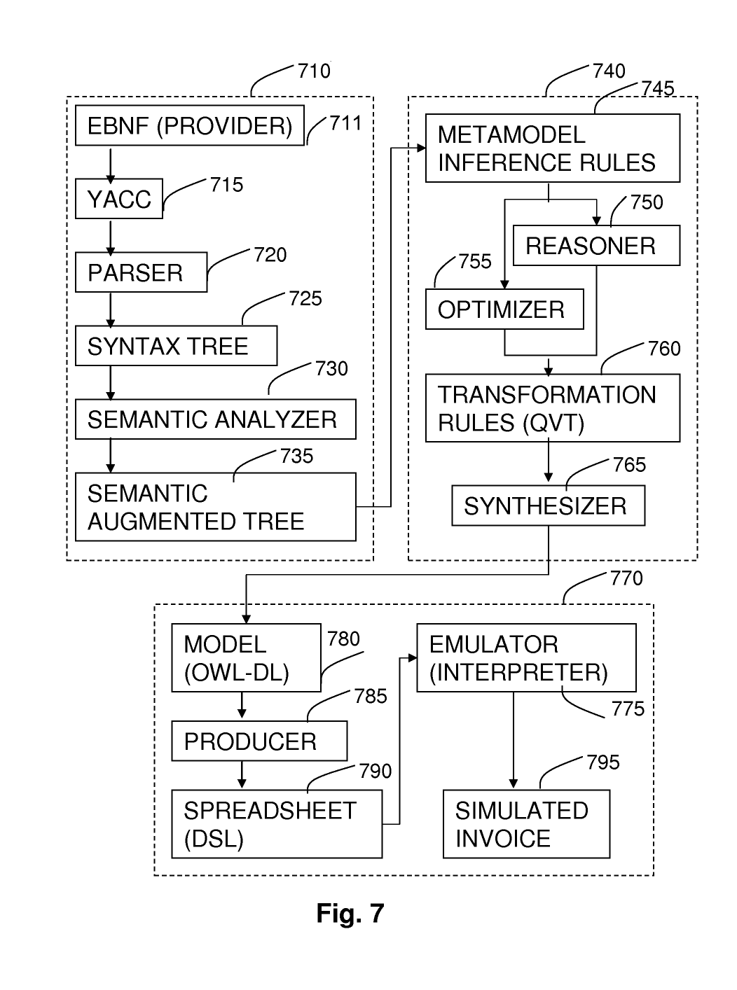

FIG. 6 is a block diagram of the relations of an implementation of an expert system for analyzing a billing system to customers and clients (consumers/end-users), according to some embodiments of the invention. A supplier (e.g. spend management platform provider) 601 supplies applications to a customer 602, which in turn supplies services to a client 603. The expert system 700, which is described in FIG. 7, is connected with a workflow engine 600 comprising an intelligent agent 610 (as an offline/batch mode) and an online module 605 for timing and controlling the workflow at the supplier's end. The intelligent agent 610 performs according to a predefined scheduler and acts upon upcoming internal and external events. The intelligent agent 610 may be fully automatic, and work in a task environment which comprises the following elements: A performance measure 615 triggering optimization and verification elements for measuring the cost of a combination of services, under given consumption profiles, in any given time; An environment 620 elements for driving the creation and update of an internal knowledge base plus detection of the appearances of new plans, packages, services, tariffs, campaigns plus new regulations, etc.; Actuators 625 comprising I/O elements for actions such as delivery of recommendations to users, calculating savings and other financial reports, updating the knowledge base, alerting for inconsistency or billing errors, etc.; Sensors 630 comprising I/O elements for the internet (for receiving new customers detail records, new invoices, plans and services, change in customer's subscriber's portfolio), as a front-end (for receiving status and updates from customer service representatives (CSR)), and comprising timers for periodically performing optimizations, changes in plans status and/or relevancy etc.

A robots generator 640 comprising GUI tools 645 for generating and updating robots 650 that harvest subscribers billing records and information. The robots 650 comprise data retrieval agents that may be operated by supplier 601, customer 602 or client 603, or be designed by the supplier 601 and delivered to use by the client 603. The robots generator 640 comprises a studio application that is used by designers 635 to design proprietary robots (i.e. robots that support the harvesting of information from a Billers web-site or internal billing systems) 650 using GUI tools only (no programming required), so that frequent changes can be implemented easily and straightforward. The robots 650 are responsible for automatically harvesting information from the billers' 660 site or billing system, including data related to customers, subscribers, plans, services and tariffs, invoices and calls details records (CDR). Billing robot 650 may be configured to work on event-driven basis i.e. start operating on events such as scheduler signal, overdue dates etc. or on manual basis, where its users decide when to initiate its operation—according the user preferences. The robots 650 comprise a package comprising a data-processing module, which is activated prior to the insertion of the harvested data to the system's data-bases and comprises the following capabilities: Data normalization capabilities (converting data from different source providers into a unified representation) and Blind data capabilities (removing all the identifying characteristics of a subscriber's data prior to usage by the expert system).

The customer 602 receives from the supplier 601 a customer interface 670 and a customer front end 680. The customer interface 670 comprises customizable widgets 672 which comprise widget software embedded in customer's web site, allowing clients to communicate with customer service representatives (CSR), to receive reports, and to register to services and download a fat client application 655. The widgets 672 may be customized to a client's white label brand by means of changing skin, logo, content etc. The customer interface 670 may further provide clients 603 with software gadgets 674, such as consumption cost rough calculators, Web 2.0 facilities to share related information, top of the day bar etc. as well as a recommendation engine 676 relating to client's preferences and choices. The customer front end 680 may be a Web-Native Front End (WNFE) providing full customer management capabilities comprising client management module 682, marketing campaigns management module 684, leads and history management module 686, and more. The WNFE comprises a software application supplied as a service to the customer 602 that is characterized by a network-based access to, and management of, commercially available (i.e., not custom) software; activities that are managed from central locations rather than at each customer's site, enabling customers to access applications remotely via the web; application delivery that typically is closer to a one-to-many model (single instance, multi-tenant architecture) than to a one-to-one model, including architecture, pricing, partnering, and management characteristics; and centralized feature updating, which obviates the need for downloadable patches and upgrades. The client 603 may receive billing robots 650 from supplier 601 or customer 602 as well as the fat client application 655 for communicating with billers 660 and customer 602.

According to some embodiments of the invention, the information flow in the system is the following: The client 603 and the customer 602 create initial contact and agreement, comprising downloading the fat client application 655 and billing robots 650 by the client 603 from the customer 602. The fat client 655 pulls CDR's and invoices from the billers 660 and sends them via web-service to the supplier 601 as blind data. The supplier 601 provides the customer 602 with optimization reports regarding the respective client 601, and the customer sends the optimization reports to the client 603. According to the reports, the client 603 may change his paying modes or assert the validity of the bills issued by the billers 660.

FIG. 7 is a block diagram of an expert system for analyzing a billing system, according to some embodiments of the invention. The expert system comprises three modules: A Natural Language Processing (NLP) module 710, a Feature Oriented Programming (FOP) module 740 and a Model Driven Development (MDD) module 770.

The NLP module 710 comprises an Extended Backus-Naur form (EBNF) provider 711. EBNF is a meta-syntax notation used to express context-free grammars: that is, a formal way to describe computer programming languages and formal languages. It is an extension of the basic Backus-Naur form (BNF) meta-syntax notation. The EBNF 711 defines production rules where sequences of symbols are respectively assigned to a non-terminal symbol. BNF is used to formalize Context-Free Grammars (CFG) which are most commonly used in mathematical system for modeling natural languages. A CFG consists of a set of Rules (or Productions), each of which expresses the ways the symbols of the language can be grouped and ordered together, and a Lexicon of words and symbols. The symbols may be either Terminal symbols i.e. symbols that correspond to words in the language or Non-terminal symbols i.e. ones that express clusters or generalizations of symbols.

The NLP module 710 further comprises a YACC and LEX module 715 for reengineering and assimilating product and service offerings' knowledge for a new service provider. The commercially available tools LEX and YACC define the syntax of the service provider's proprietary invoice language. These are declarative tools belonging to the compiler-complier class of development tools raising the abstraction level of compilers developments. LEX provides for the lexical analysis of the language i.e. identifying Tokens, while YACC provides for grammar analysis. The knowledge engineer defines the proprietary syntax as an EBNF, and YACC & LEX automatically produce a parser for the proprietary invoice language.

The NLP module 710 further comprises parsers 720 generated by YACC & LEX for parsing invoices and generating on-the-fly Abstract Syntax Trees (AST) 725. An AST 725 is a finite, labeled, directed tree, where each interior node represents a programming (i.e. invoice) language construct and the children of that node represent meaningful components of the construct. We devise operators to name these programming language constructs. Internal nodes are labeled by these operators, and the leaf nodes represent the operands of the operators. Thus, the leaf nodes are NULL operators and only represent variables or constants. An AST 725 differs from a parse tree (also known as a concrete syntax tree) by omitting nodes and edges for syntax rules that do not affect the semantics of the program. The AST tree 725 for an invoice is constructed according to the grammar rules recursively i.e. the root that represents the total, sums-up it sibling sub-totals, (themselves may represent sum of sub-totals). Each sub-total, is the sum of its sibling invoice-items, which represent a multiplication of the form Usage times Cost. Usage may represent the sum of sub-usages included in the service, and the cost may be any algebraic formula.

The NLP module 710 further comprises a Semantic Analyzer 730 utilizing First Order Logic (FOL) (also called First Order Predicate Calculus) or descriptive logic (DL) to represent semantics (i.e. meaning) as customary in NLP applications. In approaching the problem of semantic analysis (i.e. the process whereby meaning are composed and assigned to linguistic inputs) we use the syntax-driven semantic analysis method. In this fairly simple approach meaning representations are assigned to inputs based solely on static knowledge from lexicon and grammar. The key idea underling this approach is that meaning of a sentence can be composed from the meaning of its parts. In syntax-driven semantic analysis, the composition of meaning representations is guided by the syntactic components and relations provided by the CFG. Practically CFG rules are augmented with semantic attachments that can be thought of as semantic instructions that specify how to compute the meaning representation of a construction from the meanings of its constituent parts. The semantic analyzer thus turns the AST tree 725 into a semantic augmented tree 735.

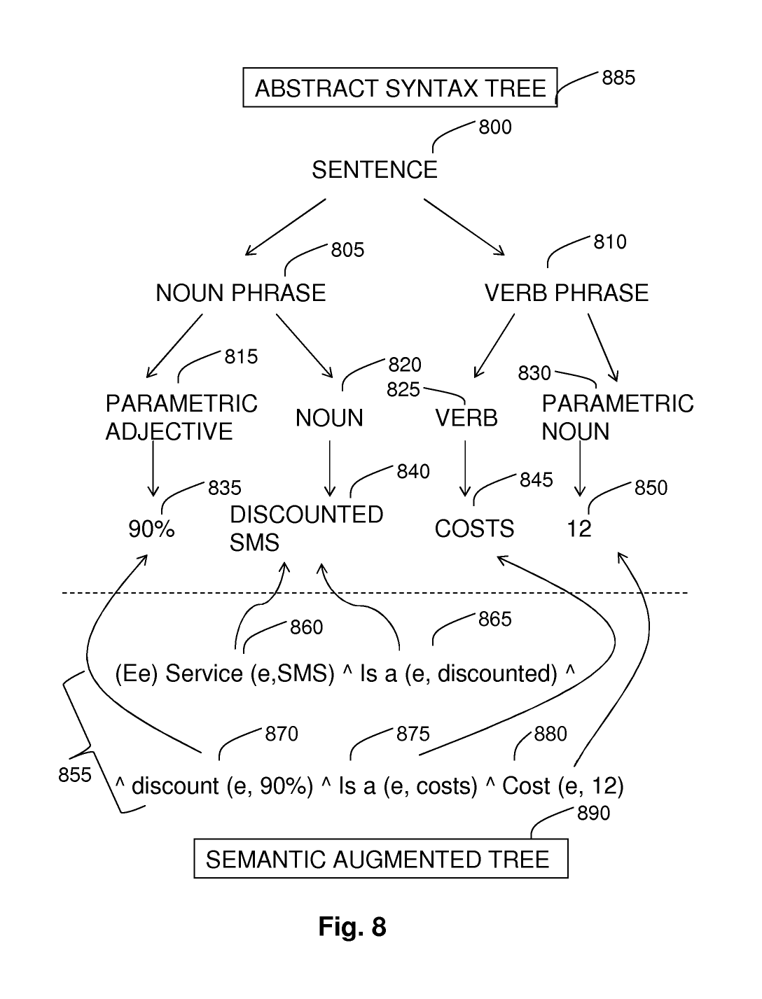

FIG. 8 is an example depicting an Abstract Syntax Trees (AST) 885 versus a semantic augmented tree 890 according to some embodiments of the invention. The sentence 800 “A 90% discounted SMS costs 12” is separated in a noun phrase 805 and a verb phrase 810, which are further separated into the noun 820 “discounted SMS” 840 and the parametric adjective 815 “90%” 835; and into the verb 825 “costs” 845 and the parametric noun 830 “12” 850. The semantic augmented tree 890 constructed by the Semantic Analyzer 730 comprises an NLP sentence 855 including parts that are mapped upon the AST—(Ee) Service (e, SMS) 860 and “Is a (e, discounted)” 865 are mapped upon “Discounted SMS” 840, “discount (e, 90%)” 870 is mapped upon “90%” 835, “Is a (e, costs)” 875 is mapped upon “costs” 845 and “Cost (e, 12)” 880 is mapped upon “12” 850.

According to some embodiments of the invention, genetic programming may be applied to the trees by taking complementing parts from different parent trees to generate an offspring tree.

The synthesizer's 765 (FIG. 7) responsibility is to compose and implant in the right hand side of the ‘=’ operator a formula that realizes the invoice-item's semantics and is written using OWL-DL (Web Ontology Language—Descriptive Logic), which is the language of choice for DSL.

The semantic analyzer 730 generates generic models written in OWL-DL that is used to describe the classes (the terms ‘Class’, ‘Frame’ and ‘Concept’ are used to describe the representation of a product or service offerings) and relations between them. Any product offering is presented in an OWL-DL model that is the composition of sibling OWL-DL models representing the features that realize the offering. Feature may be either a service or a package—containing services, where each service has a type (campaign, benefit, basic etc.) and belongs to a category (calls, content, browsing etc.) ‘DL’ in OWL-DL stands for descriptive logic which refers, on the one hand, to concept descriptions used to describe a domain and, on the other hand, to the logic-based semantics which can be given by a translation into first-order predicate logic.

The synthesizer's 765 major' mission is to form complete product offerings i.e. to generate complete models representations of the offerings' features. On receiving a the new feature to synthesize, the synthesizer 765 scans the knowledge base in order to locate existing features, which are semantically ‘similar’ to the new feature. If it finds the exact feature in the knowledge base then its job is done, else, using the transformation rules (handed to it by the reasoner 750) and conducting semantic comparisons, it tries to generate new formulas out of the existing features formulas. If the synthesizer 765 fails to complete the substitutions by itself it asks for the knowledge engineer's advice. In cases where more than one transformation is found, the synthesizer 765 requests the producer to generate a list of consumption records test cases and to produce programs using the alternative formulas. These programs are sent to the emulator 775 for validation, and the formulas that best mach the test cases are chosen. The most basic transformation rule is the overriding of a property (while the formulas are left untouched). Other transformation rules drive the “reproduction” of new feature. There are two basic forms to reproduce. 1. Mutation which is equivalent to biological Mutation (i.e. changes to the nucleotide sequence of the genetic material and introduction of new DNA to the system). 2. Crossover (Recombination) which is equivalent to biological crossover (i.e. a genetic operator used to vary the programming of a chromosome or chromosomes from one generation to the next).

The FOP module 740 utilizes the Feature Orient Programming (FOP) paradigm for realizing endogenous transformations and Software Product Lines (SPL) program synthesis where feature units are the building blocks of programs Each feature may include any number of artifacts (i.e., representations). A key challenge is how pre-built pieces are assembled together to synthesize a program product. Doing so, it is possible to synthesize automatically a customized program from customized features (i.e., increments of program functionality).

The FOP module 740 comprises a composition element for composing structure and artifacts. For example, the composition of introductions is straightforward (i.e., just copy them). The realization of a composite feature involves frequently not only source code artifacts, but other multiple representations. To attain this, composition is a polymorphic operator (i.e., a specific composer tool for each type). This allows the composition of multiple and heterogeneous artifacts. An example follows: If feature f encapsulates a set of artifacts af, bf, and df we write f={αƒ, bƒ, dƒ}. Similarly, i={αi, bi, ci} says that feature i encapsulates artifacts αi, bi, and ci. As artifacts themselves may be sets, a feature is a nested set of artifacts. The composition of features is governed by the rules of inheritance. In the composition i·f, all artifacts of f are inherited by i. Further, artifacts with the same name (ignoring subscripts) are composed pair-wise. This is the Law of Composition: i·ƒ={αi, bi, ci}·{αƒ, bƒ, dƒ}={αi·αƒ, bi·bƒ, ci, dƒ}. Features are composed by applying the Law of Composition recursively. In general, when the artifact is source code, a class refinement can introduce new data members, methods and constructors to a target class, as well as extend or override existing methods and constructors of that class.

The FOP module 740 further comprises a semantic reasoner 750, which is an application able to infer logical consequences from a set of asserted facts or axioms. The semantic reasoner 750 comprises an inference engine with a richer set of mechanisms to work with. The inference rules are commonly specified by means of an ontology language, and often a description language. The reasoned 750 uses first order predicate logic to perform reasoning and is responsible to formulate decision-procedures for the automatic generation of DL-based models.

The FOP module 740 further comprises a Feature Oriented Refactoring (FOR) module. FOR Is the inverse of feature composition. Instead of starting with a base program B and features F and G, and composing them to build program P=F·G·B, feature refactoring starts with P and re-factors P into an expression F·G·B. FOR is the process of decomposing a program into a sequence of features, that encapsulate increments in program functionality. Doing so, different compositions of features yield different programs. Features have a modular structure that we need to make explicit. To attain this, FOR manipulates program structure in a highly disciplined and sophisticated way. FOR is supported by a theory that relates code refactoring to algebraic factoring, defines relationships between features and their implementing modules, and why features in different programs of a product-line can have different implementations. FOR provides a conceptual basis of program structure and manipulation in terms of FOP.

Metamodel inference rules 745 implement a semi automatic FOR using combination of Natural Language Processing (NLP) techniques and inference rules reasoning ways to semi-automatically synthesize new formulas out of existing ones.

The reasoner 750 executes (or fires) inference rules written in OWL-DL. The OWL-DL inference rules-base is pre-defined and is constantly updated by the knowledge engineers. The reasoner 750 generates transformation rules 760 written in QVT (Queries Views Transformations, a standard for model transformation defined by the Object Management Group) that instruct the synthesizer 765 how to synthesize formulas for incomplete models. The simplest reasoner 750 inference mechanism is to override an invoice-item and simply manipulate its properties. Consider the following inference rule that involves two invoice-items 111 and 112 of the form: “If Semantically-Equal (II1, II2) then substitute-Properties (II1, II2)” ‘Semantically-Equal’ is a pre-defined predicate that compares the semantic augmented trees of the features that own the two invoice-items. The semantic comparison, ignores the so called ‘parametric’ nodes. Say the following new invoice-line is presented: “cost of 50% discounted SMS” =’, ‘8’. The predicate ‘Semantically-Equal’ apparently is satisfied, and the formula belonging to the invoice line “cost of 90% discounted SMS” =’, ‘12’ is transformed and used for new feature. e.g. if the formula for “The cost of 90% SMS deliveries” is num-of-SMS*90%, then the formula for “The cost of 50% SMS deliveries” is num-of-SMS*50%). Crossover rules have the form: “If (Invoice-Item-Formula-Is (II1,F1) AND Invoice-Item-Formula-Is (II1,F2)) then Invoice-Item-Formula-Is (II1VII2,F1VF2)” “If re-factored (I,I1,I2) then I=I1VI2. In this example, forward-chaining inference is initiated as follows: When an Invoice-Item ‘I’ arrives, such that I may be re-factored to two existing Invoice-Items ‘I1’, and ‘I2’ then according to the second rule I=I1 V I2. Continuing with the first rule we get that I's formula—‘F’ equals the logical expression ‘F1’ V ‘F2’ i.e. I's formula may be automatically composed out of the two existing formulas.

The optimizer 755 is responsible to finding the optimal product offering given a set of viable product offerings. Generally, an optimum is calculated on a list of consumption detailed records (CDR).

In order to perform its task the optimizer 755 considers the inference rules presented in the inference rules knowledge base. The rules instruct the optimizer 755 on what event it should perform, under which conditions (e.g. on the 15th of any month; A new subscriber connected etc.) and about the constraints that should be considered. (Relations between ontologies such as: subscriber is eligible to product; service is relevant to product offerings etc.) According to the underling constraints the optimizer 755 locates and filters out candidate product offerings and instructs the synthesizer 765 using QVT selection instructions.

While ‘naïve’ algorithms such as the “Brute Force” algorithm (loop on ALL candidate alternatives) may be sufficient to finding optimum in batch mode operation, they are definitely not suitable to interactive mode operation, where thousands of alternatives must be measured in real-time. We use Genetic Algorithms to solve the optimization problem as follows: A typical genetic algorithm requires two things to be defined: 1. A genetic representation of the solution domain (as described above); 2. A fitness function to evaluate the solution domain (implemented using an emulator that interprets the proprietary DSL). A potential solution to the problem (i.e. ‘alternative’) is represented as a chromosome encoded as a binary bit string. A typical chromosome may look like this: 10010101110101001010011101101110111. Each bit corresponds to a service that might be, or might not be included in the alternative solution. Instead of iterating on all possible bit combinations (i.e. Brute Force), an initial population of say, N random chromosomes is created. Then, the following steps are repeated until a solution is found: Test each chromosome to see how good it is at solving the problem at hand and assign a “fitness score” accordingly. The fitness score is a measure of how good that chromosome is at solving the problem to hand and is calculated using the emulator. Select two members from the current population. The chance of being selected is proportional to the chromosomes fitness. (‘Roulette wheel’—a way of choosing members from the population of chromosomes in a way that is proportional to their fitness. It does not guarantee that the fittest member goes through to the next generation merely that it has a very good chance of doing so. It works like this:). Imagine that the population's total fitness score is represented by a pie chart, or roulette wheel. Now you assign a slice of the wheel to each member of the population. The size of the slice is proportional to that chromosomes fitness score. i.e. the fitter a member is the bigger the slice of pie it gets. Now, to choose a chromosome all you have to do is spin the ball and grab the chromosome at the point it stops. Dependent on the ‘crossover rate’ (i.e. the chance that two chromosomes will swap their bits. A good value for this is around 0.7) crossover the bits from each chosen chromosome at a randomly chosen point. Crossover is performed by selecting a random gene along the length of the chromosomes and swapping all the genes after that point. Step through the chosen chromosomes bits and flip dependent on the ‘mutation rate’ (i.e. the chance that a bit within a chromosome will be flipped—0 becomes 1, 1 becomes 0. This is usually a very low value for binary encoded genes, say 0.001) Repeat step 2, 3, 4 until a new population of N members has been created.

The MDD (Model Driven Development) module 770 utilizes a metaprogramming paradigm to develop programs based on modeling. In general, model-driven is a paradigm to reuse specific patterns or domains of software development. The MDD module utilizes tools that are intended to support a model-driven approach: such as IBM Rationale Software design, Vanderbilt's Model Integrated Computing (MIC), Eclipse Modeling Framework (EMF), ATL (ATLAS Transformation Language) framework, Microsoft's Software Factories. MDD uses Metaprogramming, Models (Metaprograms), and Model transformations.

The emulator 775 interprets and executes the DSL program instructions (generated by the producer) one by one. While in validation mode, the emulator is able to automatically compare the resulted calculations of any instruction with billing information received from foreign billing systems, and assert exceptions using pre-defined thresholds. The emulator 775 presents additional development tools for the usage of the knowledge engineer, such as syntax verifications, tracing and other capabilities which are commonly included in commercial debuggers and compilers.

The model (OWL-DL) 780 may be managed by either the KAON2 (Karlsruhe ontology and tools based upon it) or Pellet (an open-source Java OWL DL reasoner). In our case, the so called ‘legacy applications’ are practically the foreign billing systems and the knowledge they encapsulate i.e. plans, packages, services, campaigns, tariffs and the algorithms that realize them. A question arises, how to re-factor existing offers in an optimal way, a way that will lead us to maximum reusability and automation of the reverse engineering process.

From the producer 785 point of view each product offering's model contains a ‘Production plan’, describing the way the product offering should be built. The producer's 785 major task is to generate program code out of the production plan. The generated program code is written using our declarative proprietary DSL (Domain Specific Language) on a spreadsheet 790 data structure. A program is “declarative” if it describes what something is like, rather than how to create it. This is a different approach from imperative programming languages such as Fortran, C, and Java, which require the programmer to specify an algorithm to be run. The producer 785 has two major responsibilities: 1. To generate programs for validation in favor of the synthesizer 765, 2. To generate programs for optimizations in favor of the optimizer 755.

The emulator 775 interprets and executes the DSL program instructions (generated by the producer) one by one. While in validation mode, the emulator is able to automatically compare the resulted calculations of any instruction with billing information received from foreign billing systems, and assert exceptions using pre-defined thresholds. The emulator 775 presents additional development tools for the usage of the knowledge engineer, such as syntax verifications, tracing and other capabilities which are commonly included in commercial debuggers and compilers.

The simulated invoice 795 is the product of the system and the object on which the genetic algorithms are applied and the recommendations to the customers are based. The simulated invoice 795 is supposed to be close to actual invoices based on the same data. Optimizing the system and methods may be measured by the proximity of the simulated invoices 795 to the corresponding invoices.

According to some embodiments of the invention, the system comprises a hierarchy of models, each level comprising the advantages gained in all previous levels, and presenting new benefits and higher level of abstraction, implying significant reduction of the manual work required. The system comprises the following levels:
Level 0: Imperative programming paradigm: This paradigm shares all the disadvantages that the proposed invention try to overcome, including the inherited need for intensive manual work and inability to maintain knowledge over time.
Level 1: Declarative programming: We introduce a proprietary DSL based on First-Order-Logic (FOL) the mathematical tool used to describe semantics of formal languages.
Level 2: Knowledge management & Model-driven, (metaprogramming) paradigm Model-driven programming is achieved by the maintenance of models representing ‘products’. A Product is a set of concrete product offerings described by means of ontology language. A ‘Producer’ program, takes a product model as an input, and generates automatically DSL code tailored to given consumer at given time.
Level 3: Software Product Lines (SPL) and Feature Oriented Programming (FOP) paradigm: We implement SPL & FOP by means borrowed from evolution theory. In our case an invoice-item is a building block analogous to a DNA's gene. Invoice-items realize features which stand for either a service or a package. Once sufficient number of invoice-items (i.e. genes in the gene pool) have been realized, it is possible to implement automatically large amount of product offerings (i.e. chromosomes) by synthesizing features out of invoice-items, synthesizing product-offerings out of features.
Level 4: Semi-automatic Feature Oriented Refactoring (FOR): An invoice represents a specific product offerings billing information; the apparent re-factoring of the invoice is to its invoice-items. Realization of invoice-items, concerns the implementation of formulas that simulate the computations made by a foreign billing system generating the said invoice-item. Semi-automation of the FOR implementation is achieved by using combination of Natural Language Processing (NLP) techniques and inference rules reasoning ways to semi-automatically synthesize new formulas out of existing ones.

According to some embodiments of the invention, the system utilizes methods from the Software Product Line (SPL) and Model Driven Development (MDD) emerging disciplines. In line with the meta-programming paradigm, where programs are treated as values, we treat the models as values to a producer module that given consumer consumption detailed records for a specified period, it produces programs using the product offering's model. These programs—written in proprietary domain specific language (DSL), are later interpreted on a proprietary emulator. We further raise the abstraction level, by forming Metamodels—programs/files that describe models. As suggest by the MDD paradigm, it is desired to construct models automatically out of Metamodels. Also in use is a semantic reasoner (i.e. reasoning engine, rules engine, or simply a reasoner) which is a piece of software able to infer logical consequences from a set of asserted facts or axioms that is able to generate models automatically.

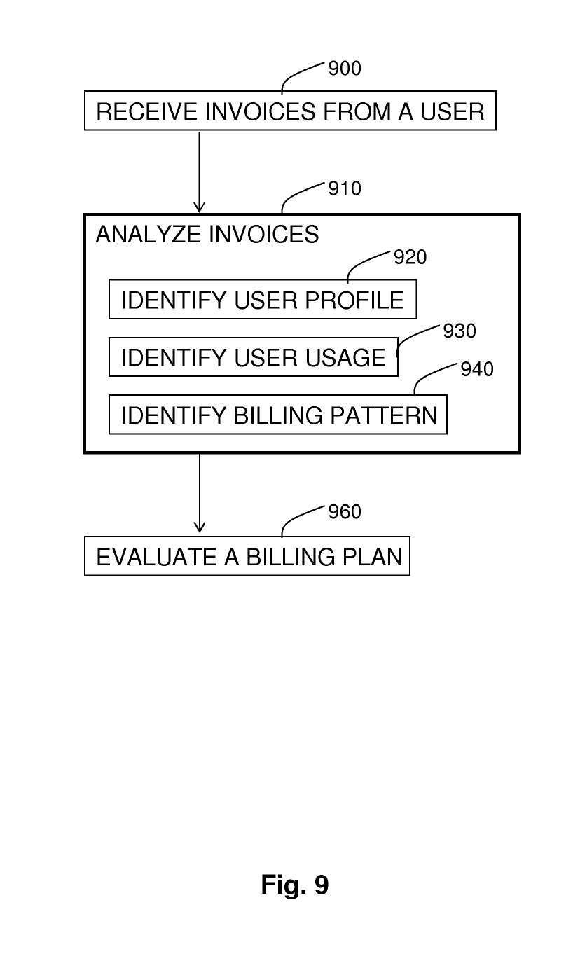

FIG. 9 is a flowchart illustrating a method for evaluating a plurality of invoices according to some embodiments of the invention. The method is used to generate recommendations relating to the invoices. The method comprises the stages:
Receiving invoices (stage 900) generated by a service provider and relating to a user profile and user usage from a user.
Analyzing the invoices (stage 910) based on a learning algorithm which applies semantic analysis and optimization with genetic algorithms. This stage comprises:
   identifying at least one parameter of the user profile (stage 920), such as relating to personal data, social status, business status etc.
   identifying user usage (stage 930), e.g. number, timing and duration of calls, types of services used etc.
   identifying parameters of a billing pattern (stage 940), such as invoice elements, correlations among them and between them and other data.

According to some embodiments of the invention, analyzing invoices (stage 910) utilizes a knowledge base comprising a data structure resulting from a prior analysis of invoices. According to some embodiments of the invention, identifying parameters of a billing pattern (stage 940) comprises extracting billing rules. According to some embodiments of the invention, the method further comprises a stage of evaluating a billing plan in relation to the identified parameters of user profile and the identified user usage.

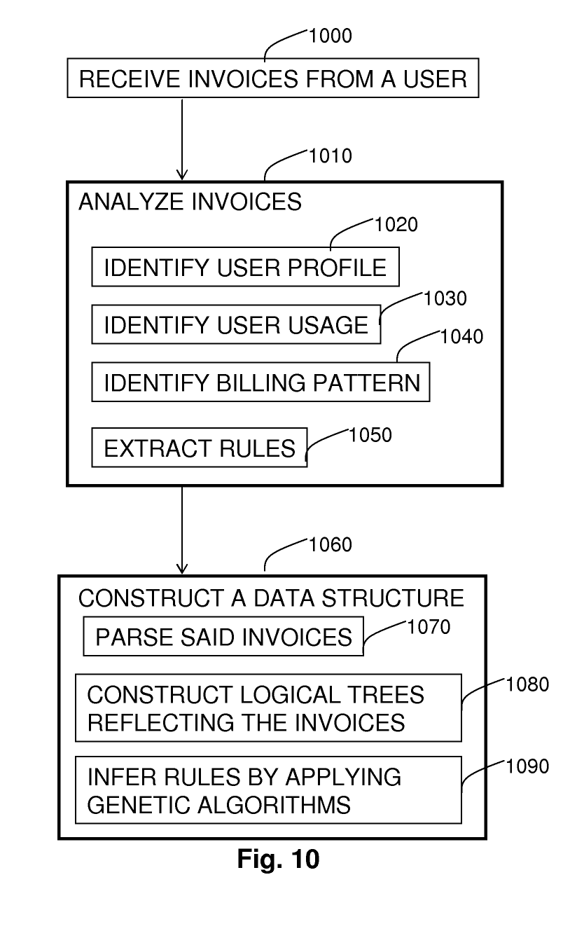

FIG. 10 is a flowchart illustrating method of constructing a knowledge base for analyzing invoices according to some embodiments of the invention. The method comprises the stages:
Receiving invoices (stage 1000) generated by a service provider and relating to a user profile and user usage from a user.
Analyzing the invoices (stage 1010) semantically and logically. This stage comprises:
   identifying at least one parameter of the user profile (stage 1020), such as relating to personal data, social status, business status etc.
   identifying user usage (stage 1030), e.g. number, timing and duration of calls, types of services used etc.
   identifying parameters of a billing pattern (stage 1040), such as invoice elements, correlations among them and between them and other data.
   extracting rules (stage 1050) of constructing an invoice from the user profile, the user usage and the parameters of billing pattern, as identified in stages 1020, 1030 and 1040.
Constructing a data structure (stage 1060) from the analyzing invoices, in a such way that the data structure represents a billing plan of the service provider, and that the data structure generates invoices from the user profile, the user usage and the parameters of billing pattern that are substantially similar to the received invoices (stage 1000).

According to some embodiments of the invention, constructing a data structure (stage 1060) comprises:
Parsing the invoices utilizes NLP and FOL (stage 1070).
Constructing logical trees reflecting the invoices (stage 1080).
Inferring the rules governing the billing pattern by applying genetic algorithms to the logical trees (stage 1090).

According to some embodiments of the invention, the knowledge base comprises a data structure for representing billing plans (relating to a user profile and user usage) of a service provider. The data structure comprises logical trees reflecting the invoices. The logical trees are based on a semantic analysis of the invoices in respect of the user profile and user usage.

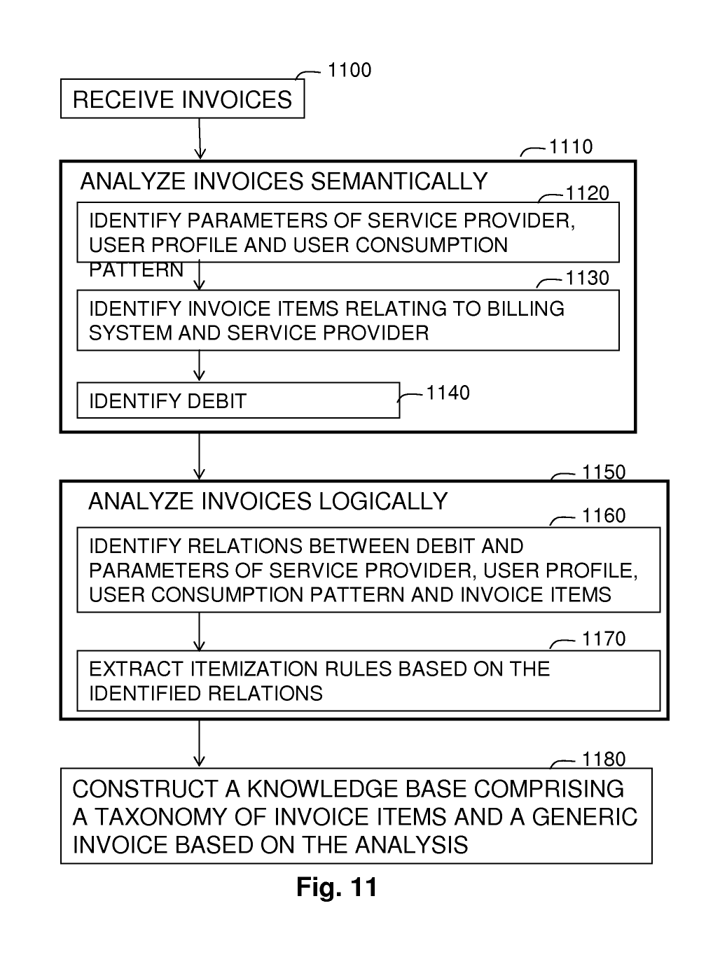

FIG. 11 is a flowchart illustrating a computer implemented method of constructing a computer implemented knowledge base, according to some embodiments of the invention. The computer implemented knowledge base relates to invoices generated by at least one billing system related to at least one service provider, according to at least one billing plan. The invoices comprise parameters of at least one user profile, invoice items, parameters of at least one user consumption pattern and at least one debit. The computer implemented method comprises the stages:
Receiving the invoices (stage 1100).
Semantic analyzing the invoices (stage 1110) comprising:
   Identifying parameters of the service provider, user profile, billing system, billing plan and user consumption pattern (stage 1120).
   Identifying the invoice items (stage 1130).
   Identifying said at least one debit (stage 1140).
Logically analyzing the invoices (stage 1150) comprising:
   Identifying relations between the debit and at least one of: parameters of the service provider, parameters of the user profile, the invoice items, and parameters of the user consumption pattern (stage 1160).
   Extracting at least one itemization rule utilizing the identified relations utilizing a reverse engineering logic (stage 1170).
Constructing a computer implemented knowledge base (stage 1180).

According to some embodiments of the invention, the computer implemented knowledge base comprises at least one taxonomy representing an hierarchic structure of the relations and inheritance between the billing plans based on the semantic and logically analyzing of the invoices (stages 1110, 1150) by identifying differences and similarities between invoices and invoice-items related to different billing plans (in one embodiment—using bioinformatics methods). The computer implemented knowledge base further comprises at least one computer implemented generic invoice for calculating an estimated debit from at least one of the following: the invoice items, parameters of the user profile and user consumption pattern. The rules are extracted from the invoices by utilizing reverse engineering logic.

According to some embodiments of the invention, the computer implemented knowledge base is used to simulate the generation of debits from the invoices.

According to some embodiments of the invention, the invoice comprises batches of invoices. Constructing the computer implemented knowledge base (stage 1180) represents the aggregated information in consequent batches of invoices.

According to some embodiments of the invention, at least part of semantic analyzing (1110) and at least part of the logically analyzing (1150) is carried out manually.

According to some embodiments of the invention, the semantic analyzing (1110) and logically analyzing (1150) utilize algorithms of bio-informatics.
Given two strings of text, X and Y, (that are phrase sequences) find the optimal way of inserting dashes into the two sequences so as to maximize a given scoring function between them.
Similar to the way a protein sequence represent a single Phenotype, a phrase sequence represent a single sentence (invoice-line) in the domain language.
Incoming invoice-lines are sequence aligned against the set of all possible invoice-lines (i.e. phenotypes) that may derive from its Gene-pool
Knowledge of evolutionary relation between a newly identified phrase sequence and a family of phrase sequences in a database may provide the first clues about the sentence structure and the formulas realizing it. Such algorithms may be used to identify similarity between invoice-items (genes) in order to locate possibilities for reuse in formalization of new invoice-items.

According to some embodiments of the invention, constructing the computer implemented knowledge base (stage 1180) further comprises connecting between the taxonomy and the generic invoice.

According to some embodiments of the invention, an itemization rule is analogous to a gene, and an invoice item is analogous to a group of Genotype's alleles, and such that the constructing the computer implemented knowledge base (1180) is carried out utilizing evolutional-trees and genetic programming techniques, applying genetic operators, and treating invoice-items as building-blocks to implementing billing plans to achieve reusability and semi-automation.

According to some embodiments of the invention, the following exemplifies the semantic analyzing (1110) and logically analyzing (1150) utilizing algorithms of bio-informatics. Consider “usage of sequence alignment algorithm”: Definition: Input: Two (or more) sequences S1, S2, . . . , Sn, and a scoring function f. Output: The alignment of S1, S2, . . . , Sn, which has the optimal score. Purpose: To determine how close two species are, To perform data compression, To determine the common area of some sequences, To construct evolutionary trees, Algorithms for solving sequence alignment problems—are well known in prior art e.g. using dynamic programming. Consider usage of “Longest common subsequence (LCS) Problem”: A string: S1=“ TAGTCACG”. A subsequence of S1: deleting 0 or more symbols from S1 (not necessarily consecutive), e.g. G, AGC, TATC, AGACG. Common subsequences of S1=“TAGTCACG” and S2=“AGACTGTC′”: GG, AGC, AGACG. Longest common subsequence (LCS):S1: TAGTCACG, S2: AGACTGTC, LCS: AGACG, and algorithms know in prior art as O(mn) solution−S1=a1 a2 . . . am and S2=b1 b2 . . . bn. Ai,j denotes the length of the longest common subsequence of a1 a2 . . . ai and b1 b2 . . . bj. Dynamic programming: Ai,j=Ai−1,j−1+1 if ai=bj, max {Ai−1,j, Ai,j−1} if ai≠bj; A0,0=A0,j=Ai,0=0 for 1≦i≦m, 1≦j≦n. Time complexity: O(mn), Also known in prior art the Hunt-Szymanski LCS Algorithm.

According to some embodiments of the invention, the method utilizes algorithms of sequence alignment adapted from the field of bioinformatics. The algorithms allow:
Finding the optimal way of inserting dashes into the two sequences so as to maximize a given scoring function between them.
The similarity score determines the probability that the sequences are evolutionarily related (e.g. one is a mutation of the other).

According to some embodiments of the invention, the algorithms of sequence alignment are utilized using the following analogy with genome analysis (analogous to product offering analysis): concept analysis is analogous to phylogenetic analysis, formula prediction is analogous to protein structure prediction and invoice line analysis is analogous to sequence analysis.

According to some embodiments of the invention, constructing (1180) the taxonomy of billing plans in the knowledge base is carried out analogous to a genetic hierarchy, such that the invoice is analogous to a cell, billing plans are analogous to chromosomes, an itemization rule is analogous to a gene, and an invoice item is analogous to a genotype, and such that constructing the computer implemented knowledge base (1180) is carried out utilizing genetic algorithms.

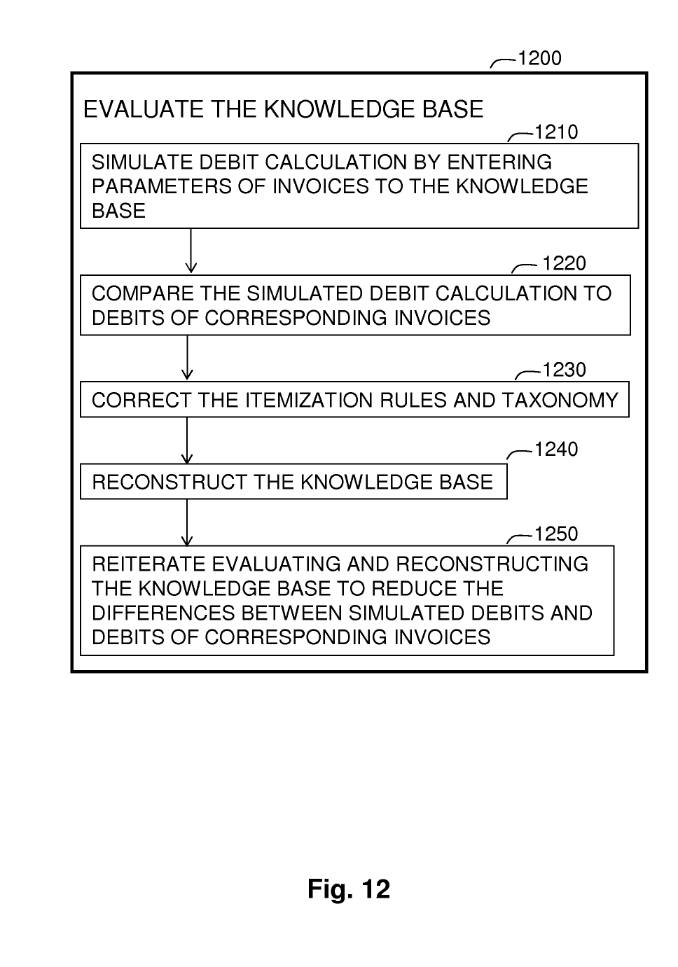

FIG. 12 is a flowchart illustrating a computer implemented method of evaluating the computer implemented knowledge base (1200) that may be added to the method illustrated in FIG. 11 according to some embodiments of the invention. The computer implemented method comprises:
Simulating debit calculation by entering parameters of invoices to the computer implemented knowledge base (stage 1210).
Comparing the results of simulating debit calculation (1210) to debits of corresponding invoices (stage 1220)
Correcting at least one of: the itemization rules, the taxonomy of billing plans, the computer implemented generic invoice (stage 1230) in relation to comparing the simulated debits to debits of corresponding invoices (1220).
Reconstructing the computer implemented knowledge base according to correcting the itemization rules (1230), the taxonomy of billing plans and the computer implemented generic invoice (stage 1240).

According to some embodiments of the invention, the computer implemented method 1200 further comprises reiterating (stage 1250) evaluating the computer implemented knowledge base (1200) and reconstructing the computer implemented knowledge base (1240) such that reconstructing the computer implemented knowledge base (1240 reduces the differences between the results of simulating debit calculation (1210) and the debits of corresponding invoices.

According to some embodiments of the invention, reiterating the evaluating and reconstructing the computer implemented knowledge base (1250) utilizes genetic operators.

According to some embodiments of the invention, reiterating the evaluating the computer implemented knowledge base and the reconstructing the computer implemented knowledge base (1250) is carried out such that some new plans resulted from reconstructing the computer implemented knowledge base reduce the differences between the results of the simulating debit calculation and the debits of corresponding invoices. In embodiments, reiterating the evaluating and the reconstructing the computer implemented knowledge base utilizes genetic programming and genetic operators.

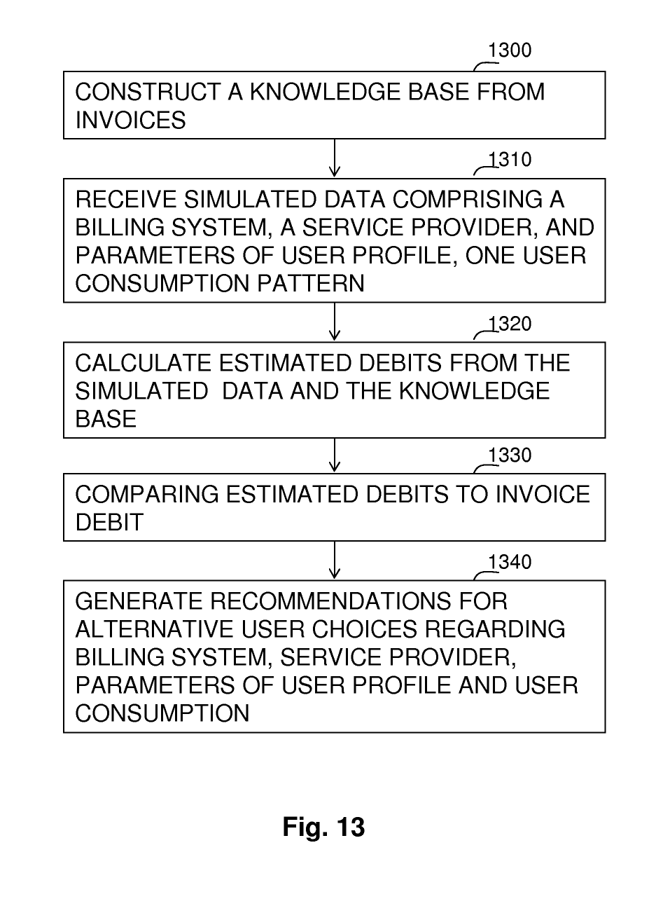

FIG. 13 is a flowchart illustrating a method of evaluating a plurality of invoices, according to some embodiments of the invention. The invoices are generated by at least one billing system according to at least one billing plan and relating to at least one service provider. The invoices comprise parameters of at least one user profile, a plurality of invoice items, parameters of at least one user consumption pattern and at least one debit. The method comprise the following stages:
Receiving said plurality of invoices (stage 1100, FIG. 11).
Analyzing the invoices comprising (i) semantic analyzing the invoices (stage 1110, FIG. 11, comprising identifying at least one of the following: parameters of service provider, of user profile, invoice items of the invoices relating to the billing system, service provider, billing plan, and parameters of the user consumption pattern, as well as the debits) and (ii) logically analyzing the invoices (stage 1150, FIG. 11, comprising identifying relations between debits and at least one of: parameters of service provider, one user profile, invoice items, user consumption pattern; and extracting itemization rules according to the identified relations)
Constructing a computer implemented knowledge base (stage 1300) comprising (i) at least one taxonomy representing an hierarchic structure of the relations and inheritance between billing plans based on semantic and logically analyzing (1110, 1150) of the invoices by identifying difference and similarities between invoice related to different billing plans, (ii) at least one computer implemented generic invoice for calculating an estimated debit from at least one of the following: invoice items, user profile and user consumption pattern, wherein the rules are extracted from the invoices by utilizing a reverse engineering logic.
Receiving simulated data (stage 1310) comprising at least one of the following: at least one billing plan, at least one billing system, at least one service provider, at least one parameter of at least one user profile, at least one parameter of at least one user consumption pattern.
Calculating at least one estimated debit from the simulated data and the computer implemented knowledge base (stage 1320). The simulated data may represent alternative user choices.

According to some embodiments of the invention, logically analyzing the invoices (1150) utilizes at least one of: first order logic, descriptive logic a combination thereof.

According to some embodiments of the invention, the method of evaluating a plurality of invoices further comprises comparing the estimated debit to the debit from the invoices (stage 1330).

According to some embodiments of the invention, the method of evaluating a plurality of invoices further comprises generating at least one recommendation for alternative user choices (stage 1340) regarding at least one of the following: at least one billing plan, at least one billing system, at least one service provider, at least one parameter of at least one user profile, at least one parameter of at least one user consumption. The recommendation is according to the results of comparing the estimated debit from the invoices (1330).

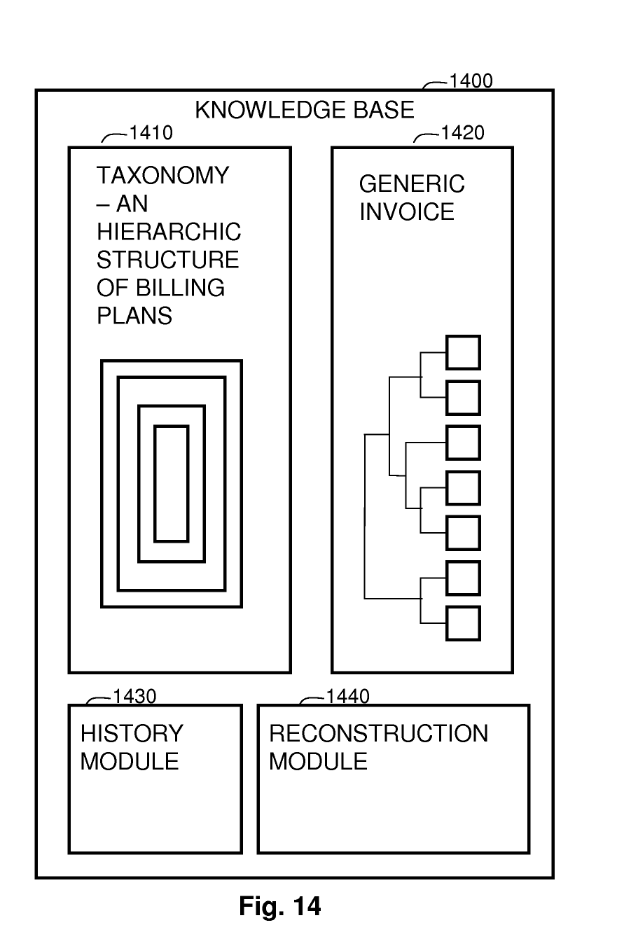

FIG. 14 is a block diagram illustrating a computer implemented knowledge base 1400 for analyzing a plurality of invoices, according to some embodiments of the invention. The invoices are generated according to at least one billing plan by at least one billing system and relating to at least one service provider. The invoices comprise parameters of at least one user profile, a plurality of invoice items, parameters of at least one user consumption pattern and at least one debit. The computer implemented knowledge base comprises at least one taxonomy 1410 and at least one computer implemented generic invoice 1420. Taxonomy 1410 represents an hierarchic structure of the relations and inheritance between the billing plans based on semantic and logically analyzing of the invoices for extracting a plurality of rules by identifying difference and similarities between invoices related to different billing plans. Computer implemented generic invoice 1420 for calculating an estimated debit from at least one of the following: the invoice items, parameters of user profile and user consumption pattern. The rules are extracted from the invoices by utilizing a reverse engineering logic.

According to some embodiments of the invention, at least one taxonomy 1410 of billing plans is constructed analogous to a genetic hierarchy, such that the invoice is analogous to a cell, billing plans are analogous to chromosomes, a rule is analogous to a gene, and an invoice item is analogous to a genotype. The taxonomy of billing plans 1410 is analyzed utilizing genetic algorithms.

According to some embodiments of the invention, computer implemented knowledge base 1400 further comprises a history module 1430 and a reconstruction module 1440. History module 1430 may be arranged to save at predefined periods a time stamp and at least one of: at least one taxonomy; at least one computer implemented generic invoice, associated with the time stamp. Reconstruction module 1440 for using a historical version of at least one of: at least one taxonomy; at least one computer implemented generic invoice. The historical version is defined by the time stamp. Reconstruction module 1440 is arranged to allow calculations with a prior version of at least one of: at least one taxonomy, at least one computer implemented generic invoice.

According to some embodiments of the invention, history module 1430 is arranged to save at predefined periods a time stamp and at least one of: at least one taxonomy; at least one computer implemented generic invoice, associated with the time stamp, (ii) a reconstruction module for using a historical version of at least one of: at least one taxonomy; at least one computer implemented generic invoice, the historical version defined by the time stamp, (iii) at least one computer implemented data-base of consumers and their relations to the taxonomy.

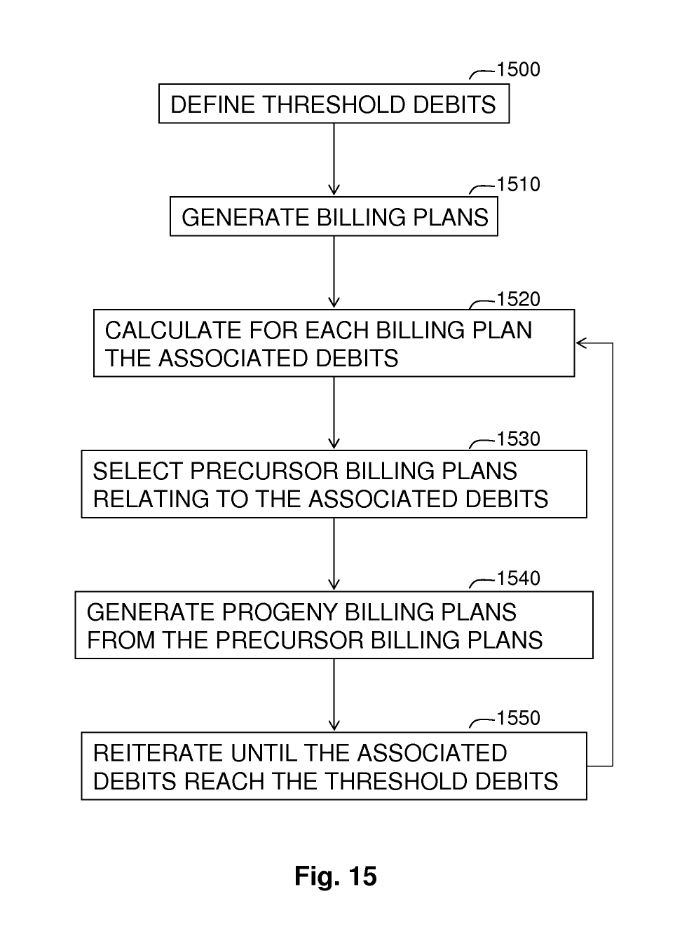

FIG. 15 is a flowchart illustrating a computer implemented method of knowledge refinement and generation related to a computer implemented knowledge base for analyzing a plurality of invoices, according to some embodiments of the invention. The invoices are generated according to at least one billing plan by at least one billing system and relating to at least one service provider. The invoices comprise parameters of at least one user profile, a plurality of invoice items, parameters of at least one user consumption pattern and at least one debit. The computer implemented knowledge base comprises at least one computer implemented generic invoice for calculating an estimated debit from at least one of the following: said plurality of invoice items, parameters of at least one user profile and parameters of at least one user consumption pattern. The computer implemented knowledge base incorporates rules extracted from the invoices by utilizing a reverse engineering logic. The computer implemented method comprises the stages:
Defining a plurality of threshold debits (stage 1500).
Generating a plurality of billing plans (stage 1510).
Calculating for each billing plan a plurality of associated debits (stage 1520).
Selecting a plurality of precursor billing plans from the billing plans relating to the plurality of associated debits (stage 1530). The selected precursor billing plans comprise billing plans minimizing at least one predefined function of said associated debits.
Generating a plurality of progeny billing plans from the precursor billing plans (stage 1540). Every progeny billing plan is substantially similar to at least one precursor billing plan.
Reiterating (stage 1550) the calculating a plurality of associated debits (1520), selecting precursor billing plans (1530) and generating a plurality of progeny billing plans (1540), reiterating 1550 is carried out until the associated debits reach the threshold debits for at least one billing plan.

According to some embodiments of the invention, generating a plurality of progeny billing plans from the plurality of precursor billing plans (1540) is carried out such that every progeny billing plan is substantially similar to at least one precursor billing plan (in one embodiment—using genetic algorithms and applying genetic operators such as Crossover and Mutation).

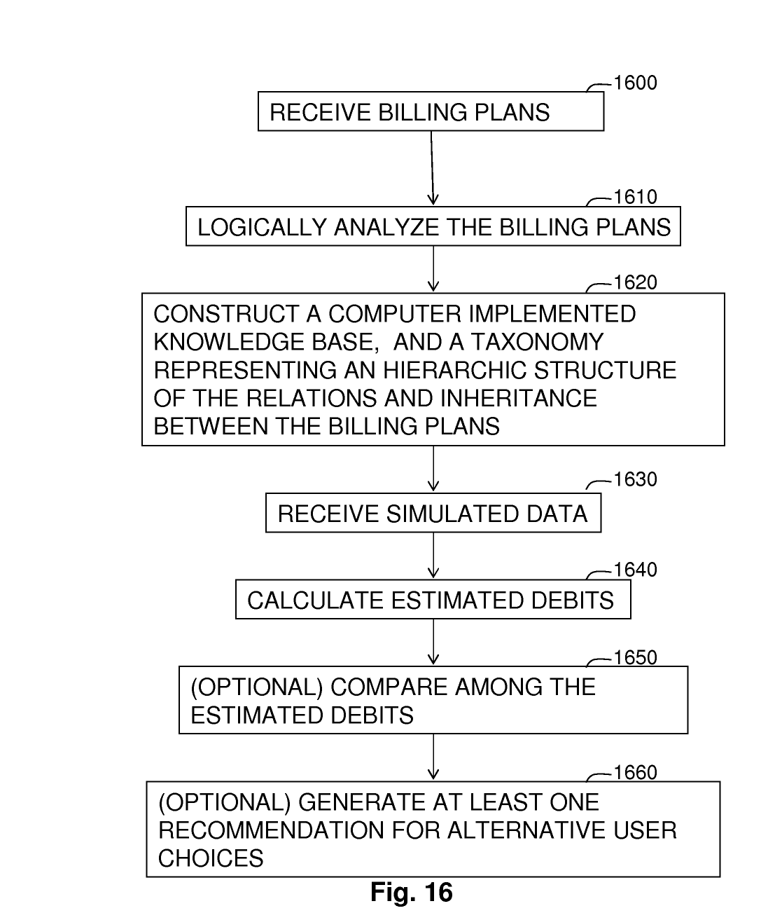

FIG. 16 is a flowchart illustrating a method of evaluating a plurality of billing plans, according to some embodiments of the invention. The billing plans are generated by at least one billing system and are related to at least one service provider. The billing plans relate to parameters of at least one user profile and parameters of at least one user consumption pattern. The method comprises the stages:
Receiving the plurality of billing plans (stage 1600);
Logically analyzing the plurality of billing plans (stage 1610) comprising identifying relations between at least one of the following: the parameters of the at least one service provider, the parameters of the at least one user profile, parameters of the plurality of billing plans, the parameters of at least one user consumption pattern; and extracting itemization rules according to the identified relations;
Constructing a computer implemented knowledge base (stage 1620) comprising at least one taxonomy representing an hierarchic structure of the relations and inheritance between the billing plans based on the logically analyzing of the plurality of billing plans by identifying difference and similarities between different billing plans;
Receiving simulated data (stage 1630) comprising at least one of the following: at least one billing plan, at least one billing system, at least one service provider, at least one parameter of at least one user profile, at least one parameter of at least one user consumption pattern;
Calculating at least one estimated debit from the simulated data and the computer implemented knowledge base (stage 1640).

According to some embodiments of the invention, the logically analyzing (stage 1610) utilizes at least one of: first order logic, descriptive logic, a combination thereof.

According to some embodiments of the invention, the method of evaluating a plurality of billing plans further comprises comparing among at least two estimated debits (stage 1650).

According to some embodiments of the invention, the method of evaluating a plurality of billing plans further comprises generating at least one recommendation for alternative user choices (stage 1660) regarding at least one of the following: at least one billing plan, at least one billing system, at least one service provider, at least one parameter of at least one user profile, at least one parameter of at least one user consumption; the at least one recommendation is according to the results of comparing among at least two estimated debits, wherein the simulated data represent the alternative user choices.

According to some embodiments of the invention, generating at least one recommendation for alternative user choices (stage 1660) utilizes genetic algorithms.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A computer implemented method of constructing a computer implemented knowledge base relating to a plurality of invoices, said invoices generated by at least one billing system according to at least one billing plan and relating to at least one service provider, said invoices comprising parameters of at least one user profile, a plurality of invoice items, parameters of at least one user consumption pattern and at least one debit, said method comprising:
receiving said plurality of invoices,
semantic analyzing said plurality of invoices, said semantic analyzing comprising:
identifying parameters of said at least one service provider;
identifying said parameters of at least one user profile;
identifying said invoice items of said plurality of invoices relating to said at least one billing system and said at least one service provider;
identifying said parameters of at least one user consumption pattern;
identifying said at least one debit;
identifying said at least one billing plan;
logically analyzing said plurality of invoices, said logically analyzing comprising:
identifying relations between said at least one debit and at least one of the following: said parameters of said at least one service provider, said parameters of said at least one user profile, said plurality of invoice items, said parameters of at least one user consumption pattern;
extracting at least one itemization rule utilizing identified relations, wherein said itemization rules utilize a reverse engineering logic;
constructing said computer implemented knowledge base, said computer implemented knowledge base comprising:
at least one taxonomy representing an hierarchic structure of the relations and inheritance between said billing plans based on said semantic and logically analyzing of said plurality of invoices by identifying difference and similarities between invoice related to different billing plans;
at least one computer implemented generic invoice for calculating an estimated debit from at least one of the following: said plurality of invoice items, said parameters of at least one user profile and said parameters of at least one user consumption pattern, wherein said at least one rule is extracted from said plurality of invoices by utilizing a reverse engineering logic.

2. The computer implemented method of claim 1, wherein said computer implemented knowledge base is used to simulate the generation of said debit from said plurality of invoices.

3. The computer implemented method of claim 1, wherein said plurality of invoices comprises a plurality of batches of invoices, and wherein said constructing said computer implemented knowledge base represents the aggregated information in consequent batches of invoices.

4. The computer implemented method of claim 1, wherein at least part of said semantic analyzing and at least part of said logically analyzing is carried out manually.

5. The computer implemented method of claim 1, further comprising:
evaluating said computer implemented knowledge base, said evaluating comprising:
simulating debit calculation by entering parameters of invoices to said computer implemented knowledge base;
comparing the results of said simulating debit calculation to debits of corresponding invoices;
correcting at least one of said itemization rules, said at least one taxonomy of said billing plans and said computer implemented generic invoice in relation to said comparing of said simulated debits to debits of corresponding invoices;
reconstructing said computer implemented knowledge base according to said correcting at least one of said itemization rules, said at least one taxonomy of said billing plans and said computer implemented generic invoice.

6. The computer implemented method of claim 5, further comprising reiterating said evaluating said computer implemented knowledge base and said reconstructing said computer implemented knowledge base such that said reconstructing said computer implemented knowledge base reduces the differences between said results of said simulating debit calculation and said debits of corresponding invoices.

7. The computer implemented method of claim 6, wherein said reiterating said evaluating and said reconstructing said computer implemented knowledge base utilizes genetic operators.

8. The computer implemented method of claim 1, wherein said semantic analyzing and said logically analyzing utilize algorithms of bio-informatics.

9. The computer implemented method of claim 1, wherein said constructing said at least one taxonomy of billing plans in said knowledge base is carried out analogous to a genetic hierarchy, such that said invoice is analogous to a cell, billing plans are analogous to chromosomes, an itemization rule is analogous to a gene, and an invoice item is analogous to a genotype, and such that said constructing said computer implemented knowledge base is carried out utilizing genetic algorithms.

10. A method of evaluating a plurality of invoices, said invoices generated by at least one billing system according to at least one billing plan and relating to at least one service provider, said invoices comprising parameters of at least one user profile, a plurality of invoice items, parameters of at least one user consumption pattern and at least one debit, said method comprising:
receiving said plurality of invoices;
analyzing said plurality of invoices, said analyzing comprising:
semantic analyzing said plurality of invoices, said semantic analyzing comprising identifying at least one of the following: Parameters of said at least one service provider, said parameters of at least one user profile, said invoice items of said plurality of invoices relating to said at least one billing system and said at least one service provider, said at least one billing plan, said parameters of at least one user consumption pattern, and said at least one debit;
logically analyzing said plurality of invoices, said logically analyzing comprising identifying relations between said at least one debit and at least one of the following: Said parameters of said at least one service provider, said parameters of said at least one user profile, said plurality of invoice items, said parameters of at least one user consumption pattern; and extracting itemization rules according to the identified relations;
constructing a computer implemented knowledge base, said computer implemented knowledge base comprising:
at least one taxonomy representing an hierarchic structure of the relations and inheritance between said billing plans based on said semantic and logically analyzing of said plurality of invoices by identifying difference and similarities between invoices related to different billing plans;
at least one computer implemented generic invoice for calculating an estimated debit from at least one of the following: said plurality of invoice items, said parameters of at least one user profile and said parameters of at least one user consumption pattern, wherein said at least one itemization rule is extracted from said plurality of invoices by utilizing a reverse engineering logic,
receiving simulated data comprising at least one of the following: at least one billing plan, at least one billing system, at least one service provider, at least one parameter of at least one user profile, at least one parameter of at least one user consumption pattern;
calculating at least one estimated debit from said simulated data and said computer implemented knowledge base.

11. The computer implemented method of claim 10, wherein said logically analyzing utilizes at least one of: first order logic, descriptive logic, a combination thereof.

12. The method of claim 10, further comprising comparing said at least one estimated debit to said at least one debit.

13. The method of claim 10, further comprising generating at least one recommendation for alternative user choices regarding at least one of the following: at least one billing plan, at least one billing system, at least one service provider, at least one parameter of at least one user profile, at least one parameter of at least one user consumption;
said at least one recommendation is according to said results of comparing said at least one estimated debit to said at least one debit, wherein said simulated data represent said alternative user choices.

14. The method of claim 13, wherein said generating at least one recommendation for alternative user choices utilizes genetic algorithms.

15. A method of evaluating a plurality of billing plans, said billing plans generated by at least one billing system and relating to at least one service provider, said billing plans relating to parameters of at least one user profile, and parameters of at least one user consumption pattern, said method comprising:
receiving said plurality of billing plans;
logically analyzing said plurality of billing plans, said logically analyzing comprising identifying relations between said at least one debit and at least one of the following: Said parameters of said at least one service provider, said parameters of said at least one user profile, parameters of said plurality of billing plans, said parameters of at least one user consumption pattern; and extracting itemization rules according to the identified relations;
constructing a computer implemented knowledge base, said computer implemented knowledge base comprising at least one taxonomy representing an hierarchic structure of the relations and inheritance between said billing plans based on said logically analyzing of said plurality of billing plans by identifying difference and similarities between different billing plans;
receiving simulated data comprising at least one of the following: at least one billing plan, at least one billing system, at least one service provider, at least one parameter of at least one user profile, at least one parameter of at least one user consumption pattern;
calculating at least one estimated debit from said simulated data and said computer implemented knowledge base.

16. The computer implemented method of claim 15, wherein said logically analyzing utilizes at least one of: first order logic, descriptive logic, a combination thereof.

17. The method of claim 15, further comprising comparing among at least two estimated debits.

18. The method of claim 15, further comprising generating at least one recommendation for alternative user choices regarding at least one of the following: at least one billing plan, at least one billing system, at least one service provider, at least one parameter of at least one user profile, at least one parameter of at least one user consumption; said at least one recommendation is according to said results of comparing among at least two estimated debits, wherein said simulated data represent said alternative user choices.

19. The method of claim 15, wherein said generating at least one recommendation for alternative user choices utilizes genetic algorithms.

20. A computer implemented knowledge base for analyzing a plurality of invoices, said invoices generated according to at least one billing plan by at least one billing system and relating to at least one service provider, said invoices comprising parameters of at least one user profile, a plurality of invoice items, parameters of at least one user consumption pattern and at least one debit, said computer implemented knowledge base comprising:
at least one taxonomy representing an hierarchic structure of the relations and inheritance between said billing plans based on semantic and logically analyzing of said plurality of invoices for extracting a plurality of rules by identifying differences and similarities between invoices related to different billing plans;
at least one computer implemented generic invoice for calculating an estimated debit from at least one of the following: said plurality of invoice items, said parameters of at least one user profile and said parameters of at least one user consumption pattern, wherein said plurality of rules is extracted from said plurality of invoices by utilizing a reverse engineering logic.

21. The computer implemented knowledge base of claim 20, wherein said at least one taxonomy of billing plans is constructed analogous to a genetic hierarchy, such that said invoice is analogous to a cell, billing plans are analogous to chromosomes, an itemization rule is analogous to a gene, and an invoice item is analogous to a genotype, and such that said at least one taxonomy of billing plans is analyzed utilizing genetic algorithms.

22. The computer implemented knowledge base of claim 20, further comprising:
a history module arranged to save at predefined periods a time stamp and at least one of: at least one taxonomy; at least one computer implemented generic invoice, associated with the time stamp; and
a reconstruction module for using a historical version of at least one of: at least one taxonomy; at least one computer implemented generic invoice, said historical version defined by the time stamp,
wherein the reconstruction module is arranged to allow calculations with a prior version of at least one of: at least one taxonomy, at least one computer implemented generic invoice.

23. A computer implemented method of knowledge refinement and generation related to a computer implemented knowledge base for analyzing a plurality of invoices, said invoices generated according to at least one billing plan by at least one billing system and relating to at least one service provider, said invoices comprising parameters of at least one user profile, a plurality of invoice items, parameters of at least one user consumption pattern and at least one debit, said computer implemented knowledge base comprising at least one computer implemented generic invoice for calculating an estimated debit from at least one of the following: said plurality of invoice items, said parameters of at least one user profile and said parameters of at least one user consumption pattern,
said computer implemented method comprising:
defining a plurality of predefined threshold debits;
generating a plurality of billing plans;
calculating for each billing plan a plurality of associated debits;
selecting a plurality of precursor billing plans from said plurality of billing plans relating to the plurality of associated debits, such that the selected precursor billing plans comprise billing plans minimizing at least one predefined function of said associated debits;
generating a plurality of progeny billing plans from said plurality of precursor billing plans, such that every progeny billing plan is substantially similar to at least one precursor billing plan;
reiterating said calculating a plurality of associated debits, said selecting precursor billing plans and said generating a plurality of progeny billing plans, said reiterating is carried out until the at least one predefined function of said associated debits reaches the predefined threshold debits for at least one billing plan.
